(19) United States
(12) Patent Application Publication
(10) Pub. No.: US 2025/0051613 A1
(43) Pub. Date: Feb. 13, 2025

(54) PLASMA MODIFICATION OF ADHESIVE AND SUBSTRATE SURFACES FOR USE IN ADHESIVE JOINT APPLICATIONS

(71) Applicant: Battelle Memorial Institute, Richland, WA (US)

(72) Inventors: Yao Qiao, Richland, WA (US); Yongsoon Shin, Richland, WA (US); Daniel R. Merkel, Richland, WA (US); Kevin L. Simmons, Richland, WA (US)

(21) Appl. No.: 18/797,019

(22) Filed: Aug. 7, 2024

Related U.S. Application Data
(60) Provisional application No. 63/531,112, filed on Aug. 7, 2023.

(51) Int. Cl. C09J 5/02; C09J 163/00

(52) U.S. Cl. CPC C09J 5/02; C09J 163/00; C09J 2301/416; C09J 2301/50; C09J 2400/163; C09J 2400/226

(57) ABSTRACT

Methods for producing adhesive joints through the application of plasma treatment of both substrates and adhesives are disclosed. The methods involve plasma treating the substrate surfaces to enhance their surface energy and promote better adhesion. The adhesive—whether in the form of an adhesive strip or a flowable adhesive—is also subjected to plasma treatment. This dual treatment results in adhesive joints with enhanced lap shear strength and resistance to debonding. The enhanced performance of the adhesive joints is attributed to the increased intra-molecular bonding at the substrate/adhesive interfaces, enabled by the plasma treatments.

### REFERENCE TO RELATED APPLICATION

This application claims the benefit of U.S. Provisional Patent Application No. 63/531,112, filed on Aug. 7, 2023, the disclosure of which is incorporated herein by reference in its entirety.

### STATEMENT AS TO THE RIGHTS TO INVENTIONS MADE UNDER FEDERALLY SPONSORED RESEARCH OR DEVELOPMENT

This invention was made with Government support under Contract DE-AC0576RL01830 awarded by the U.S. Department of Energy. The Government has certain rights in the invention.

### TECHNICAL FIELD

The present disclosure generally relates to methods for producing adhesive joints using plasma-treated substrates and adhesives, as well as the adhesive joints made by the processes disclosed herein.

### BACKGROUND

The adhesive joining of dissimilar materials, such as metals and polymers, is essential in many engineering applications including battery enclosures, wind turbine blades, automobiles, rocket motors, flight vehicles, and more. However, weak interfacial bonding between polymers and adhesives can lead to operational difficulties when attempting to adhesively join polymers with other materials. Thus, it would be beneficial to develop new methods for producing adhesive joints that overcome these drawbacks, resulting in joints with enhanced lap shear strength and damage resistance.

Plasma treatment is a known technique for improving adhesion to various substrates. Plasma consists of a collection of free-moving electrons and ions and is typically, electrically neutral, created by adding energy to a gas. In industrial and manufacturing processes, plasma treatments are used to modify the surface energy of a substrate. This modification can help to improve adhesion. However, plasma treatment comes with unwanted side effects, in that sufficiently high energy delivery through plasma can cause damage to the polymer itself, resulting in brittle, non-tacky adhesives that fail to wet out across the entirety of the surface to which they are applied. Accordingly, plasma treatment is only a partial solution to the problem of increasing strength of structural adhesive joints.

### SUMMARY

This summary is provided to introduce a selection of concepts in a simplified form that are further described below in the detailed description. This summary is not intended to identify required or essential features of the claimed subject matter. Nor is this summary intended to be used to limit the scope of the claimed subject matter.

Methods to produce an adhesive joint are disclosed herein. In accordance with an aspect, one such method can comprise plasma treating a first substrate at a first power level to form a plasma-treated first substrate surface, plasma treating a second substrate at a second power level to form a plasma-treated second substrate surface, plasma treating a top surface and a bottom surface of an exposed adhesive strip at a third power level to form a plasma-treated exposed adhesive strip, joining the plasma-treated first substrate surface and the plasma-treated second substrate surface together with the plasma-treated exposed adhesive strip, and curing the plasma-treated exposed adhesive strip to produce the adhesive joint. Notably, the plasma treatment of the first substrate at a first power level, the plasma treatment of the second substrate at a second power level, and the plasma treatment of the exposed adhesive strip at a third power level can be performed in any order, or simultaneously, before joining the plasma-treated first substrate surface and the plasma-treated second substrate surface together with the plasma-treated exposed adhesive strip.

Consistent with an aspect is an adhesive joint made by the process of plasma treating a first substrate at a first power level to form a plasma-treated first substrate surface, plasma treating a second substrate at a second power level to form a plasma-treated second substrate surface, plasma treating a top surface and a bottom surface of an exposed adhesive strip at a third power level to form a plasma-treated exposed adhesive strip, joining the plasma-treated first substrate surface and the plasma-treated second substrate surface together with the plasma-treated exposed adhesive strip, and curing the plasma-treated exposed adhesive strip to produce the adhesive joint. As previously discussed, the plasma treatment of the first substrate at a first power level, the plasma treatment of the second substrate at a second power level, and the plasma treatment of the exposed adhesive strip at a third power level can be performed in any order, or simultaneously, before joining the plasma-treated first substrate surface and the plasma-treated second substrate surface together with the plasma-treated exposed adhesive strip.

In accordance with another aspect is an adhesive joint made by the process of plasma treating a first substrate at a first power level to form a plasma-treated first substrate surface, plasma treating a second substrate at a second power level to form a plasma-treated second substrate surface, applying a layer of flowable adhesive onto the plasma-treated second substrate surface and plasma treating the layer of flowable adhesive at a third power level to form a plasma-treated layer of flowable adhesive, joining the plasma-treated first substrate surface with the plasma-treated layer of flowable adhesive positioned on the plasma-treated second substrate surface, and curing the plasma-treated layer of flowable adhesive to produce the adhesive joint. Notably, the plasma treatment of the first substrate at a first power level and the plasma treatment of the second substrate at a second power level can be performed in any order, or simultaneously, before applying a layer of flowable adhesive onto the plasma-treated second substrate surface.

Both the foregoing summary and the following detailed description provide examples and are explanatory only. Accordingly, the foregoing summary and the following detailed description should not be considered to be restrictive. Further, features or variations may be provided in addition to those set forth herein. For example, certain aspects may be directed to various feature combinations and sub-combinations described in the detailed description.

### BRIEF DESCRIPTION OF THE FIGURES

FIG. 1A is a perspective view of an example plasma pen used to direct a plasma stream to a targeted area on a substrate surface.

FIG. 1B is a perspective view of an example plasma generator or reactor used to plasma-treat a top surface and a bottom surface of an exposed adhesive strip.

FIG. 2 is a plot of the surface energy of an adhesive strip as a function of time that has elapsed after the adhesive strip was plasma-treated.

FIG. 3 is a perspective view of an adhesive joint produced by a method disclosed herein.

FIG. 4 presents a schematic flow diagram of a method for producing an adhesive joint consistent with an aspect.

FIG. 5 presents a schematic flow diagram of a method for producing an adhesive joint wherein the first substrate, the second substrate, and the exposed adhesive strip can be plasma-treated in any order or simultaneously.

FIG. 6 presents a schematic flow diagram of a method for producing an adhesive joint consistent with an aspect.

FIG. 7 presents a schematic flow diagram of a method for producing an adhesive joint wherein the first substrate and the second substrate can be plasma-treated in any order or simultaneously.

FIG. 8 is a plot of the surface energy of an adhesive as a function of plasma treatment time according to one example.

FIG. 9A is a plot of the surface energy of another example adhesive and the surface energy of that adhesive after plasma treatment.

FIG. 9B is a plot of the surface energy of adhesive of FIG. 8 and the surface energy of that adhesive after plasma treatment.

FIG. 10A is a plot of the surface energy of aluminum as a function of different plasma treatment parameters.

FIG. 10B is a plot of the surface energy of as-received carbon-fiber reinforced polyphthalamide (CFRPPA) and plasma-treated CFRPPA as a function of different plasma treatment parameters.

FIG. 11A shows ATR-FTIR spectra for both the as-received and plasma-treated adhesive of FIG. 9B.

FIG. 11B is a plot of the peak intensity ratios for the adhesive of FIGS. 9B and 11A.

FIG. 12A shows ATR-FTIR spectra for both the as-received and plasma-treated adhesive of FIG. 9A.

FIG. 12B shows the peak intensity ratios for the as-received and plasma-treated adhesive of FIGS. 9A and 12A.

FIG. 13A shows ATR-FTIR spectra for both the as-received and plasma-treated CFRPPA substrate of FIG. 10B.

FIG. 13B shows the average peak intensity ratio as between 1726 cm⁻¹ to 1744 cm⁻¹ for as-received and plasma-treated CFRPPA substrate.

FIG. 14A presents wide scan X-ray photoelectron spectroscopy (XPS) spectra for the as-received and plasma-treated adhesive of FIGS. 9B, 11A, and 11B.

FIG. 14B is a plot of the atomic composition obtained from the XPS spectra results for the as-received and plasma-treated adhesive of FIGS. 9B, 11A, 11B, and 14A.

FIG. 15A shows wide scan XPS spectra for the as-received and plasma-treated adhesive of FIGS. 9A, 12A, and 12B.

FIG. 15B is a plot of the atomic composition obtained from the XPS results for the as-received and plasma-treated adhesive of FIG. 15A.

FIG. 16A is a wide scan XPS spectrum for the as-received and plasma-treated CFRPPA substrate.

FIG. 16B is a plot of the atomic composition obtained from the XPS results for the as-received and plasma-treated CFRPPA substrate.

FIG. 17 is a simplified perspective schematic view of a single-lap-joint specimen setup for the single lap shear tests performed in the examples herein.

FIG. 18A depicts load-displacement curves obtained from the single lap shear tests on AA6061-CFRPPA joint specimens.

FIG. 18B depicts the nominal or lap sheer strength of the single lap shear joints.

FIG. 19A depicts the substrate surface morphology after single lap shear testing of the Comparative Example B joints with non-treated substrates and adhesive.

FIG. 19B depicts the substrate surface morphology after single lap shear testing of the Comparative Example A joints with plasma-treated substrates and non-treated adhesive.

FIG. 19C depicts the substrate surface morphology after single lap shear testing of the Inventive Example 1 joints with plasma-treated substrates and adhesive.

FIG. 20 illustrates the reaction scheme of covalent bond formation at the substrate—PX5005F adhesive interfaces in a representative adhesive joint.

FIG. 21A depicts the interfacial voids between CFRPPA and PX5005F adhesive observed from AA6061 surfaces after single lap shear testing for the Comparative Example B joints.

FIG. 21B depicts the interfacial voids between CFRPPA and PX5005F adhesive observed from AA6061 surfaces after single lap shear testing for the Inventive Example 1 joints.

FIG. 22A shows the equivalent diameter of interfacial voids between CFRPPA and PX5005F adhesive surfaces for Comparative Example B.

FIG. 22B shows maximum depth of interfacial voids between CFRPPA and PX5005F adhesive surfaces for Comparative Example B.

FIG. 22C shows equivalent diameter of interfacial voids between CFRPPA and PX5005F adhesive surfaces for Comparative Example A.

FIG. 22D shows the maximum depth of interfacial voids between CFRPPA and PX5005F adhesive surfaces for Comparative Example A.

FIG. 22E shows equivalent diameter of interfacial voids between CFRPPA and PX5005F adhesive surfaces for Inventive Example 1.

FIG. 22F shows maximum depth of interfacial voids between CFRPPA and PX5005F adhesive surfaces for Inventive Example 1.

### DEFINITIONS

To define more clearly the terms used herein, the following definitions are provided. Unless otherwise indicated, the following definitions are applicable to this disclosure. If a term is used in this disclosure but is not specifically defined herein, the definition from the IUPAC Compendium of Chemical Terminology, 2nd Ed (1997), can be applied, as long as that definition does not conflict with any other disclosure or definition applied herein, or render indefinite or non-enabled any claim to which that definition is applied. To the extent that any definition or usage provided by any document incorporated herein by reference conflicts with the definition or usage provided herein, the definition or usage provided herein controls.

Herein, features of the subject matter are described such that, within particular aspects, a combination of different features can be envisioned. For each and every aspect and/or feature disclosed herein, all combinations that do not detrimentally affect the compositions and processes described herein are contemplated with or without explicit description of the particular combination. Additionally, unless explicitly recited otherwise, any aspect and/or feature disclosed herein can be combined to describe inventive features consistent with the present disclosure.

In this disclosure, while compositions and processes are often described in terms of “comprising” various components or steps, the compositions and processes also can “consist essentially of” or “consist of” the various components or steps, unless stated otherwise.

The terms “a,” “an,” and “the” are intended to include plural alternatives, e.g., at least one. For instance, the disclosure of “a curing agent” or “an epoxy resin” is meant to encompass one, or combinations of more than one, curing agent or epoxy resin, unless otherwise specified.

The term “substrate” or “adherend” are used herein to describe to any material surface that is intended to be bonded to another surface using an adhesive.

The term “plasma treating” is used herein to describe processes/methods in which the materials are plasma-treated in any manner and for any length of time, unless otherwise specified. For example, the materials can be plasma-treated in some manner or by any suitable method or technique.

The term “joining” is used herein to describe processes/methods in which two or more substrates are brought into contact with each other.

Various numerical ranges are disclosed herein. When a range of any type is disclosed or claimed, the intent is to disclose or claim individually each possible number that such a range could reasonably encompass, including end points of the range as well as any sub-ranges and combinations of sub-ranges encompassed therein, unless otherwise specified. As a representative example, the present disclosure recites that the weight ratio of the metallocene compound to the activator-support in a catalyst composition can be in certain ranges. By a disclosure that an adhesive joint has a lap shear strength of from 10 MPa to 40 MPa, the intent is to recite that the lap shear strength can be any lap shear strength in the range and, for example, can include any range or combination of ranges from 10 MPa to 40 MPa, such as from 12 MPa to 35 MPa, or from 15 MPa to 30 MPa, and so forth. Likewise, all other ranges disclosed herein should be interpreted in a manner similar to this example.

Although any methods, devices, and materials similar or equivalent to those described herein can be used in the practice or testing, the typical methods, devices, and materials are herein described.

All publications and patents mentioned herein are incorporated herein by reference in their entirety for the purpose of describing and disclosing, for example, the constructs and methodologies that are described in the publications and patents, which might be used in connection with the present disclosure.

### DETAILED DESCRIPTION

Disclosed herein are methods for producing adhesive joints in which the surfaces of both the substrates or adherends and the adhesive are modified by plasma treatment. Adhesive joints made by the foregoing processes are also disclosed herein. The strength of adhesion, wettability on the substrate, and structural strength of the adhesive itself can be improved by using differing energy levels of plasma treatment on each of the surfaces of the adhesive, as well as the surfaces of the materials being bonded together, to adjust surface energies of those materials as desired. This approach has advantages over conventional approaches such as cross-linking through annealing, UV irradiation, or other similar approaches in which there is an inherent tradeoff between structural stability and adhesion (e.g., more energy applied to an adhesive could cause better adhesion but too much can cause chain scission and degradation of the structural strength of the adhesive itself).

Achieving a strong bond between dissimilar or similar materials requires balancing these issues related to all of surface energy, wettability, and adhesion properties, which may sometimes be in conflict with one another. Therefore, one objective is to produce adhesive joints that overcome these issues and display exceptional lap shear strength, wettability, and debonding resistance.

Advantageously and unexpectedly, the surface modification methods disclosed herein, which involve plasma treating both the adhesive and substrates at different and customizable energy levels from one another, generate stronger interfacial bonding in joints composed of similar or dissimilar materials. Furthermore, the methods disclosed herein increase the amount of activated chemical groups on both adhesive and substrate surfaces, enabling the formation of more and stronger intra-molecular bonds at the substrate/adhesive interfaces.

The integration of dissimilar materials, specifically metal and fiber-reinforced polymer (FRP), has become an indispensable practice across diverse industries, spanning from aerospace and automotive to infrastructure and marine applications and beyond. Among the various methods (e.g., screws, welds, rivets, adhesive, etc.) employed to achieve this integration, adhesive bonding has emerged as a promising approach due to its ability to address concerns related to corrosion, bonding compatibility, and design flexibility. In the wind turbine industry, for instance, certain locations in the assembly of a turbine blade require adhesive joining of metal shear web and fiber-reinforced polymer (FRP) skins. Likewise, in the automotive industry, various locations in a vehicle demand the adhesive bonding of metal-FRP dissimilar materials, such as battery packs and enclosures, roof and floor assembly, and others. The use of adhesives to bond metallic and FRP components can also be found in the aviation industry, including the emerging field of urban air mobility. This bonding technique in aviation has been primarily used for secondary structures or lightly loaded airframe components. Moreover, an adhesive-bonded primary aircraft structure, including components that are highly loaded, can also be implemented in general aviation aircraft.

Throughout the continuous development of adhesively-bonded metal-FRP dissimilar joints across various industries, joint quality has consistently remained a critical focus due to occasional observations of failures in those adhesively-bonded structural components. There are various reasons that can cause the failure of general adhesively-bonded structures, such as improper methods employed during adhesive joint design, manufacturing-induced defects like interfacial voids and kissing bond resulting from inadequate processing control, and insufficient chemical bonding between the adhesive and adherend.

Tremendous research efforts have been dedicated to developing methods to mitigate the risks arising from the aforementioned failure reasons. Just to name a few, the strategy of using probabilistic models, machine learning, multi-scale computational modeling, and their combinations has been proposed for the failure prediction and design of general adhesively-bonded joints. On the other hand, various nondestructive techniques (NDT) (e.g., ultrasonic inspection, laser bond inspection, X-ray computed tomography, etc.) have been explored to detect the interfacial void and kissing bond defects to ensure the safety of general adhesively-bonded joints. More importantly, various surface and adhesive modification methods have been investigated to strengthen the interfacial physical and chemical bonding between adhesive and adherend, aiming to achieve a robust adhesively-bonded structure. These methods include laser treatment, chemical coating, plasma treatment, nanoreinforcement, and surface topology modifications. Among these methods, plasma surface treatment possesses various advantages such as time efficiency and a minimized environmental impact.

Firstly, various plasma sources, including air, oxygen, nitrogen, argon, other gases, and mixtures thereof, have been investigated with the aim of improving the interfacial chemical bonding between adherend and adhesive. Secondly, various plasma treatment parameters, such as treatment speed, nozzle-to-tip distance, plasma power, plasma duration, and stepover distance, have also been investigated to search for the optimal treatment conditions for different material types of adhesive joints. Furthermore, the environment-related effects on adhesive joints with plasma-treated adherends have also been investigated. For instance, experiments have been conducted on the effects of air exposure time between the completion of plasma treatment and the adhesive joining of adherends, as well as the impact of severe temperature-moisture conditions.

The foregoing air plasma treatment with a set of optimized treatment parameters could lead to a significant improvement, reaching a few hundred percentage points, in lap shear strength, as well as other fatigue and fracture properties compared to that of non-treated adhesive joints, depending on the adherend materials. The enhanced debonding resistance observed among different adhesives and substrates is attributed to the generation of functional chemical groups on the adherend surface (e.g., hydroxyl, carbonyl, carboxylic, amine, etc.), and the subsequent chemical reaction leading to the formation of interfacial bonds between the adherend and the adhesive. Additionally, the physical changes of the adherend surface condition (e.g., surface roughness, surface auto-correlation length, surface patterning, etc.) can also contribute to the enhanced bonding performance of the joints. The concentration of the chemical groups and the level of surface physical changes due to plasma treatment depend on the gas and treatment parameters used in the plasma modification process.

### Methods for Producing an Adhesive Joint

Disclosed herein are methods for producing an adhesive joint. One such method can comprise plasma treating a first substrate at a first power level to form a plasma-treated first substrate surface, plasma treating a second substrate at a second power level to form a plasma-treated second substrate surface, plasma treating a top surface and a bottom surface of an exposed adhesive strip at a third power level to form a plasma-treated exposed adhesive strip, joining the plasma-treated first substrate surface and the plasma-treated second substrate surface together with the plasma-treated exposed adhesive strip, and curing the plasma-treated exposed adhesive strip to produce the adhesive joint. Notably, the plasma treatment of the first substrate at a first power level, the plasma treatment of the second substrate at a second power level, and the plasma treatment of the exposed adhesive strip at a third power level can be performed in any order, or simultaneously, before joining the plasma-treated first substrate surface and the plasma-treated second substrate surface together with the plasma-treated exposed adhesive strip.

Generally, the features of the methods (e.g., the plasma treatments, the first substrate, the first power level, the plasma-treated first substrate surface, the second substrate, the second power level, the plasma-treated second substrate surface, the top surface and the bottom surface of the exposed adhesive strip, the third power level, the plasma-treated exposed adhesive strip, the adhesive joint produced, the conditions under which each of the steps are conducted, among others) are independently described herein and these features can be combined in any combination to further describe the disclosed processes. Moreover, additional method steps can be performed before, during, and/or after any of the steps in the methods disclosed herein, and can be utilized without limitation and in any combination to further describe these methods, unless stated otherwise. Further, any adhesive joints made in accordance with the disclosed methods are within the scope of this disclosure and are encompassed herein.

Plasma treatments are conducted on a first substrate at a first power level to produce a plasma-treated first substrate surface, on a second substrate at a second power level to produce a plasma-treated second substrate surface, and on a top surface and a bottom surface of an exposed adhesive strip at a third power level to form a plasma-treated exposed adhesive strip. The first substrate, second substrate, and exposed adhesive strip can be plasma-treated in any order or simultaneously.

In accordance with the methods disclosed herein, the first substrate and the second substrate can be made of the same material. Thus, the adhesive joint produced is composed of similar substrates or adherends. Alternatively, the first substrate can be composed of a material different from that of the second substrate. Thus, the adhesive joint produced is composed of dissimilar substrates or adherends.

The first substrate utilized in the methods disclosed herein can contain any suitable material or mixture of materials or any material or mixture of materials disclosed herein. In some aspects, the first substrate can comprise a thermoplastic, a carbon-fiber reinforced thermoplastic, a glass-fiber reinforced thermoplastic, a natural-fiber reinforced thermoplastic, or any combination thereof. In a particular aspect, the first substrate comprises a carbon-fiber modified thermoplastic and the carbon-modified thermoplastic is a carbon-fiber reinforced polyphthalamide (CFRPPA).

The second substrate utilized in the methods disclosed herein can contain any suitable material or mixture of materials or any material or mixture of materials disclosed herein. In some aspects, the second substrate can comprise a metal, a metal alloy, or any combination thereof. In a particular aspect, the second substrate comprises a metal and/or a metal alloy and the metal and/or metal alloy comprises aluminum.

Any suitable plasma generator or reactor can be utilized to plasma-treat the first substrate and the second substrate in the methods disclosed herein. In a plasma generator or reactor, typically a gas or a mixture of gases is introduced into the reaction chamber and an electrical field is applied to ionize the gas or gaseous mixture. This is generally done using a power supply that creates an electric field within the reactor. The energy from this field excites the gas molecules, causing them to ionize and form plasma.

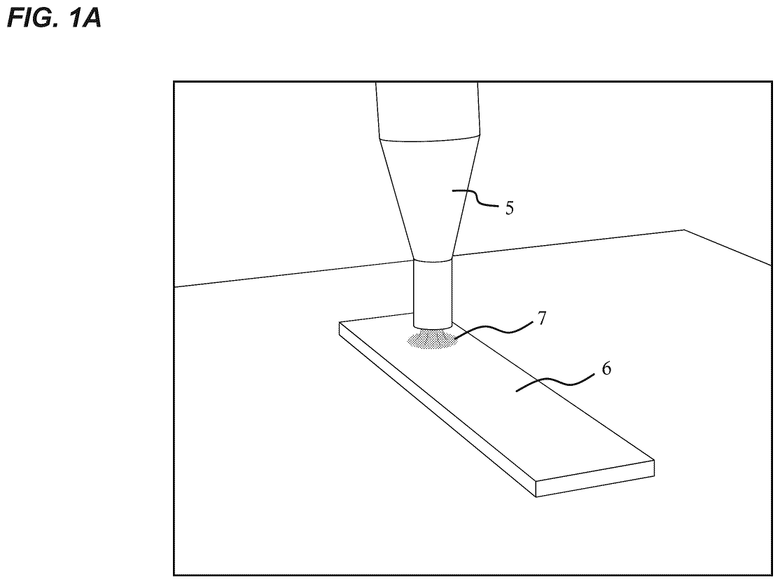

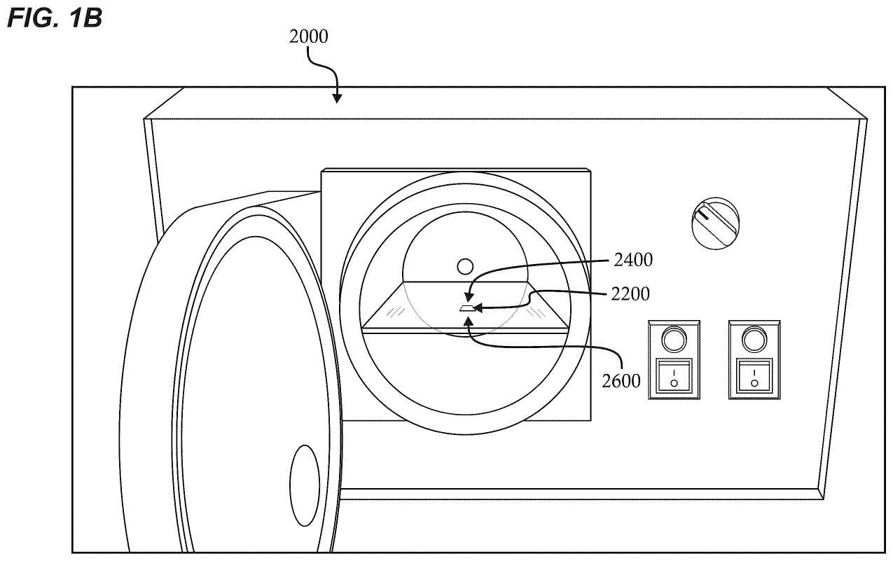

Consistent with this disclosure, the plasma generator or reactor used for plasma treating the first substrate and the second substrate is a blown-ion plasma system. Typically, the plasma treatment is applied exclusively to at least the area of the first and second substrate surfaces that will be bonded with the adhesive. Thus, it can be beneficial for the plasma generator or reactor to be equipped with a handheld or mounted tool (e.g., a plasma pen) that directs the plasma stream to a targeted area on the first and second substrate. Referring now to FIG. 1A, which illustrates plasma treatment of a first substrate with a plasma pen 5. The plasma pen 5 allows for targeted plasma treatment of the first substrate surface 6. The targeted plasma treatment ensures that the bonding area of the first substrate surface 7 (i.e., the area of the first substrate surface that will be bonded with an adhesive) has the optimal surface properties for adhesion. This ultimately leads to stronger and more durable bonded regions in an adhesive joint. Additionally, with the plasma pen 5, treatment parameters such as power, distance, and duration for specific areas can be finely adjusted, ensuring consistent and controlled surface modification. This is especially important for the bonding area of the first substrate surface 7, as the first substrate is typically made from a polymeric material. For example, excessive heat during plasma treatment can lead to degradation of the first substrate.

To further describe the plasma generator or reactor, typically, a gas or mixture of gases is introduced into the plasma generator or reactor. In a particular aspect, the gas or mixture of gases introduced into the plasma generator or reactor comprises compressed air gas. The principle behind plasma surface treatment for enhancing interfacial adhesion between a substrate and adhesive involves the activation of surface chemical groups. This process depends on the types of gases introduced into the plasma generator or reactor and enables the formation of more and stronger intra-molecular bonds at the interface. Such plasma generators or reactors can be used in various embodiments in addition to or replacing the plasma pen 5 shown in FIG. 1A.

In the methods disclosed herein the first substrate is plasma-treated at a first power level and the second substrate is plasma-treated at a second power level. The first and second power level refer to the rate at which energy is supplied to the plasma within the plasma reactor. Adjusting these power levels allows for the precise control of plasma intensity, thereby regulating the amount of energy applied to the substrate or adhered surface.

In an embodiment, the first power level and the second power level are the same. Thus, the first substrate and the second substrate are plasma-treated at the same power level. In an aspect, the first power level generates enough plasma energy to activate the functional groups on the first substrate surface. Generally, the functional groups activated on the first substrate surface, through plasma treatment, can include, but are not limited to, hydroxyl groups, carboxyl groups, carbonyl groups (e.g., hydrated and/or monomeric), amine groups, amide groups, and/or any combination thereof. However, as one of skilled in the art would readily recognize, the types of functional groups activated on the surface of the first substrate depend on many factors, including the type of substrate utilized and other processing parameters.

In an aspect, the second power level generates enough plasma energy to activate the functional groups on the second substrate surface. Generally, the functional groups activated on the second substrate surface, through plasma treatment, can include, but are not limited to, hydroxyl groups, carboxyl groups, carbonyl groups (e.g., hydrated and/or monomeric), amine groups, amide groups, and/or any combination thereof. However, as one of skilled in the art would readily recognize, the types of functional groups activated on the surface of the second substrate depend on many factors, including the type of substrate utilized and other processing parameters. Different substrates may require differing applications of plasma at different energy levels to generate different functional groups. The amount and energy level of the plasma applied, in different embodiments, can be varied as needed to generate the amount and type of functional groups that are desired and can be based upon the substrate material.

The first and second power levels of the plasma reactor can be controlled to regulate the energy supplied to the plasma and achieve the desired surface modifications without damaging the first and second substrates. When the first and/or second power level is too high, it can induce crosslinking within the first and/or second substrate. This can alter the mechanical properties of the substrates, making them more rigid and potentially brittle. Crosslinking can also affect the adhesion properties of the first and second substrate surfaces, reducing their effectiveness for subsequent bonding. Excessively high levels of plasma energy can also cause chain scission within the first and second substrates. This leads to a weakening of the materials and can potentially cause it to lose its structural integrity and mechanical strength. Thus, in an aspect, the first power level generates a controlled amount of plasma energy to prevent crosslinking and/or chain scission within the first substrate. Likewise, in some aspects, the second power level generates a controlled amount of plasma energy to prevent crosslinking and/or chain scission within the second substrate. Properly controlling the first and second power level ensures that the plasma treatment activates the surface or the substrates without causing excessive crosslinking or chain scission.

Generally, in the methods disclosed herein, the exposed adhesive strip is formed by removing a backing on the top and/or bottom from a tape-type adhesive to expose the top and bottom surfaces of the adhesive. The exposed adhesive strip can include at least one epoxy resin, at least one curing agent, and/or at least one additive. Any suitable epoxy resin, curing agent, and/or additive can be present in the exposed adhesive strip. In a non-limiting aspect, the at least one epoxy resin in the exposed adhesive strip is a phenol-formaldehyde polymer with glycidyl ether, bisphenol A-epoxy resin, diglycidylether-bisphenol A (DGEBA), an acrylic polymer, and/or any combination thereof. In another non-limiting aspect, the at least one curing agent in the exposed adhesive strip is dicyandiamide (DICY), ethylenediamine, triethylenetetramine, diethylenetriamine, phthalic anhydride, maleic anhydride, and/or any combination thereof. In a particular aspect, the at least one curing agent in the exposed adhesive strip is dicyandiamide (DICY). In yet another non-limiting aspect, the at least one additive in the exposed adhesive strip is a filler, plasticizer, stabilizer, tackifier, cross-linking agent, solvent, colorant, and/or any combination thereof.

The top and bottom surfaces of the exposed adhesive strip are plasma treated at a third power level to form a plasma-treated exposed adhesive strip. Any suitable plasma generator or reactor can be utilized to plasma-treat the top and bottom surfaces of the exposed adhesive strip in the methods disclosed herein. In an aspect, the plasma generator or reactor used for plasma treating the top and bottom surfaces of the exposed adhesive strip is a low-power expanded plasma cleaner with an adjustable radio frequency setting. In an aspect, a gas or mixture of gases is introduced into the plasma generator or reactor. In a particular aspect, the gas or mixture of gases introduced into the plasma generator or reactor comprises oxygen and/or argon. In a particular aspect, a gaseous mixture of oxygen and argon is introduced into the plasma generator or reactor for plasma treating the top and bottom surfaces of the exposed adhesive strip.

In FIG. 1B, an example plasma generator or reactor used to plasma-treat a top and a bottom surface of an exposed adhesive strip is depicted. The plasma generator or reactor 2000 is a low-power expanded plasma cleaner with an adjustable radio frequency setting, as seen in FIG. 1B. The exposed adhesive strip 2200 can be placed into the plasma generator chamber to receive the desired plasma treatment. The chamber is designed to create a controlled environment where the plasma can interact with and modify the top surface 2400 and the bottom surface 2600 of the exposed adhesive tape. The top surface 2400 and the bottom surface 2600 of the exposed adhesive strip 2200 can be plasma-treated in any order or simultaneously. For instance, the top surface 2400 of the exposed adhesive tape 2200 can be treated first, and then the bottom surface 2600 of the exposed adhesive tape 2200 can be treated second. Alternatively, the bottom surface 2600 of the exposed adhesive tape 2200 can be treated first, and then the top surface 2400 of the exposed adhesive tape 2200 can be treated second. When plasma treating the exposed adhesive strip 2200, release liners can be utilized in order to prevent the adhesive from sticking to the glass in the plasma generator chamber or any other surface.

Notably, the low energy plasma utilized for treated a top and a bottom surface of an exposed adhesive strip in the disclosed methods can be generated by any suitable plasma generator or reactor, system, or method or any plasma generator or reactor, system, or method disclosed herein. For instance, a continuous flow system can be utilized for low energy plasma generation in which conveyor belts transport materials (e.g., exposed adhesive strips) through in-line plasma chambers where they are exposed to plasma for a specified period of time. Continuous flow systems are advantageous for large-scale operations. Likewise, batch processing can be utilized for low energy plasma generation in which multiple materials (e.g., exposed adhesive strips) are placed in batch chambers for simultaneous plasma treatment. This processing method ensures uniform and precise plasma surface modification of the materials. Furthermore, roll-to-roll systems can be used for treating continuous rolls of materials (e.g., exposed adhesive strips) in which materials are unwound from a roll, treated with plasma, and then rewound. This method is beneficial for large-scale production of surface modified materials.

The plasma treatments at the first and second power levels for the first and second substrate surfaces previously discussed can easily cause the adhesive to crosslink due to the high temperatures generated by the plasma. Thus, consistent with an aspect, the first power level and the second power level (used for plasma treating the first and second substrates) are higher than the third power level.

The third power level can be chosen such that it generates enough plasma energy to activate the functional groups on the top surface and on the bottom surface of the exposed adhesive strip. Generally, the functional groups activated on the top and bottom surfaces of the exposed adhesive strip, through plasma treatment, can include, but are not limited to, epoxy groups, carbonyl groups, nitrile groups, amine groups, hydroxyl groups, and/or any combination thereof. However, as one of skilled in the art would readily recognize, the types of functional groups activated on the top and bottom surfaces of the exposed adhesive strip depend on many factors, including the type of adhesive utilized and other processing parameters.

The third power level of the plasma reactor can be controlled to regulate the energy supplied to the plasma and achieve the desired surface modifications without damaging the exposed adhesive strip. When the third power level is too high, it can induce crosslinking and/or chain scission within exposed adhesive strip. This can reduce the adhesive's effectiveness for subsequent bonding. Thus, consistent with an aspect, the third power level generates a controlled amount of plasma energy to prevent cross-linking and/or chain scission within the exposed adhesive strip.

The top and bottom surfaces of the exposed adhesive strip can be plasma-treated for any suitable period of time. In general, the top and bottom surfaces of the exposed adhesive strip can be plasma-treated for a period of time sufficient to activate the functional groups on the top and bottom surfaces. In a particular, non-limiting aspect, the top and bottom surfaces of the exposed adhesive strip are both plasma-treated for 10 minutes.

As previously mentioned, the top and bottom surfaces of the exposed adhesive strip can be plasma-treated simultaneously or in any order. For instance, the top surface of the exposed adhesive strip can plasma-treated before the bottom surface of the exposed adhesive strip. Alternatively, the bottom surface of the exposed adhesive strip can be plasma-treated before the top surface of the exposed adhesive strip.

During plasma treatment, the surfaces of the first substrate, the second substrate, and the exposed adhesive strip are exposed to energetic particles and radicals generated in the plasma. These species can break chemical bonds on the aforementioned surfaces and create new functional groups. The newly created functional groups can significantly enhance the surface energy and wettability of the first substrate surface, the second substrate surface, and the top and bottom surfaces of the exposed adhesive strip. The chemical bond density refers to the density of these newly created functional groups per unit area of the surface.

Thus, consistent with an aspect, the chemical bond density at the surface of the plasma-treated first substrate is greater than the chemical bond density at the surface of the first substrate before plasma treatment. Likewise, in an aspect, the chemical bond density at the surface of the plasma-treated second substrate is greater than the chemical bond density at the surface of the second substrate before plasma treatment. In yet another aspect, the chemical bond density at the top surface and the bottom surface of the plasma-treated exposed adhesive strip is greater than the chemical bond density at the top surface and the bottom surface of the exposed adhesive strip before plasma treatment.

In the methods for producing an adhesive joint disclosed herein, the plasma-treated first substrate surface and the plasma-treated second substrate surface are joined together with the plasma-treated exposed adhesive strip. Typically, the plasma-treated exposed adhesive strip is utilized for joining the substrates together shortly after being plasma-treated, as its enhanced surface energy is time-sensitive.

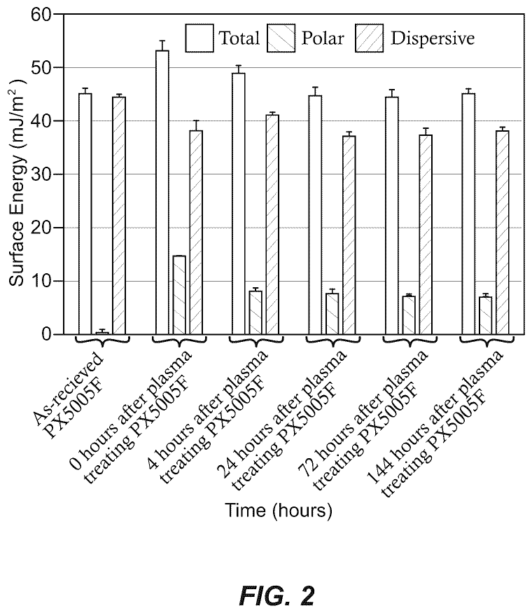

As shown in FIG. 2, which illustrates a plot of the surface energy of a representative adhesive strip (i.e., PX5005F adhesive) as a function of time that has elapsed after the adhesive strip was plasma-treated, the total surface energy, the polar component of surface energy, and the dispersive component of surface energy of the adhesive strip surface decreased in the time following plasma treatment. Specifically, the total surface energy of the adhesive surface decreased 7% four hours after plasma treatment and 15% twenty-four hours after plasma treatment. Thus, it can be beneficial to bond the plasma-treated first and second substrates together with the plasma-treated exposed adhesive strip shortly after plasma-treating the adhesive due to its time-sensitive nature.

Typically, the plasma-treated first substrate surface and the plasma-treated second substrate surface are joined together with the plasma-treated exposed adhesive strip under pressure. Any suitable amount of pressure may be applied to join the plasma-treated first substrate surface and the plasma-treated second substrate surface together with the plasma-treated exposed adhesive strip.

After joining the plasma-treated first substrate surface and the plasma-treated second substrate surface together with the plasma-treated exposed adhesive strip, the plasma-treated exposed adhesive strip is cured to produce the adhesive joint. The plasma-treated exposed adhesive strip can be cured using any suitable method. Suitable curing methods include, but are not limited to, thermal curing, UV curing, and/or electron beam curing. As one of skilled in the art would readily recognize, the choice of curing method may depend on the nature and composition of the adhesive and/or substrates. In a particular aspect, the plasma-treated exposed adhesive strip is cured in a conventional oven at 150° C.

Additionally, the plasma-treated exposed adhesive strip can be cured for any suitable period of time. In general, the plasma-treated exposed adhesive strip can be cured for a period of time sufficient to cure the plasma-treated exposed adhesive strip. In a particular, non-limiting aspect, the plasma-treated exposed adhesive strip is cured for 45 minutes to form the adhesive joint.

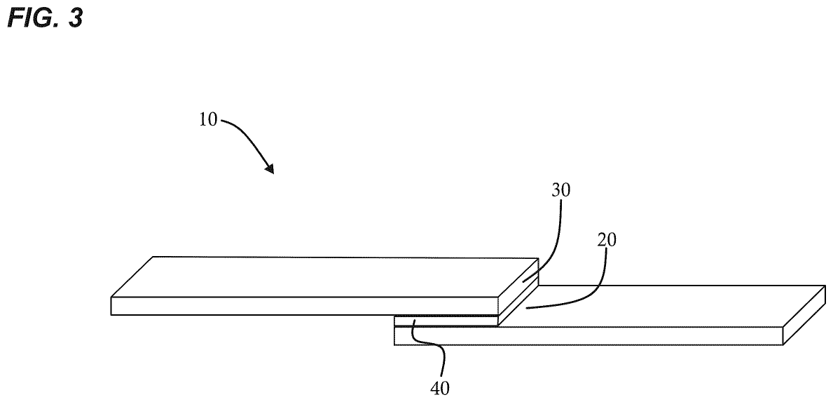

A representative adhesive joint 10 produced by a method consistent with this disclosure is depicted in FIG. 3. As shown in FIG. 3, the plasma-treated first substrate surface 20 and the plasma-treated second substrate surface 30 are bonded together with the plasma-treated exposed adhesive strip 40, forming adhesive joint 10.

The adhesive joints disclosed herein, comprising the plasma-treated first substrate and the plasma-treated second substrate joined together with the plasma-treated exposed adhesive strip, unexpectedly display exceptional lap shear strength and resistance to debonding. Thus, in accordance with an aspect, the lap shear strength of the adhesive joint is greater than the lap shear strength of an adhesive joint in which the exposed adhesive strip was not plasma-treated. In a non-limiting aspect, the adhesive joint has a lap shear strength of from 10 MPa to 40 MPa, from 12 MPa to 35 MPa, or from 15 MPa to 30 MPa.

The unexpected increase in lap shear strength and accompanying resistance to debonding of the adhesive joints produced by the methods disclosed herein can be attributed to the formation of a denser network of intra-molecular bonds between the substrates and adhesive. In a non-limiting example, plasma treatment on the first and second substrate surfaces can active more hydroxyl groups, and plasma treatment of the exposed adhesive tape surfaces can activate epoxy groups. As a result, the activated hydroxyl groups on the substrate surfaces initiate the opening of the epoxy rings on the adhesive surfaces and form covalent bonds. This polymerization process further leads to the formation of cross-linked bonds at the substrate/adhesive interfaces. The formation of a denser cross-linked network of covalent bonds formed due to the hydroxyl-initiated epoxy ring opening polymerization is particularly important for an adhesive joint with a polymer/adhesive interface to make this interface more resistance to debonding.

Additionally, plasma-induced physical changes of interfacial microstructural features also contribute to the unexpected lap shear strength and resistance to debonding of the adhesive joints. For the adhesive joints produced by the methods disclosed herein, a decrease in interfacial void area fraction at substrate/adhesive interfaces can be observed when both the substrates and adhesive are plasma-treated. Thus, in an aspect, the interfacial void area fraction (V_{if}) percentage of interfacial voids between the plasma-treated exposed adhesive strip and the plasma-treated first substrate is less than the interfacial void area fraction (V_{if}) percentage of an adhesive joint in which the exposed adhesive strip is not plasma-treated. Beneficially, the decreased interfacial void area fraction can mitigate the stress concentration among interfacial voids, and reduce the negative effect of the interfacial voids at the substrate-adhesive interface on the lap shear behavior.

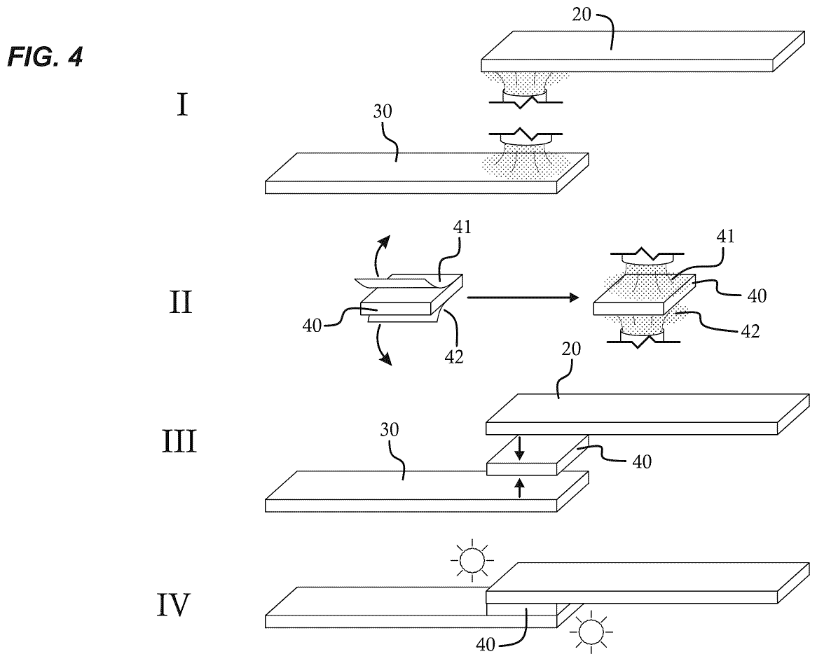

Referring now to FIG. 4, which illustrates a schematic flow diagram of a method for producing an adhesive joint consistent with an aspect. Illustration I depicts plasma treating the first substrate 20 and the second substrate 30. Illustration II depicts removing the backings or liners (terms used interchangeably herein) on the top surface 41 and the bottom surface 42 of a tape-type adhesive 40, and then subsequent plasma treating of the top surface 41 and the bottom surface 42 of the exposed adhesive tape 40. Illustration III depicts joining together the plasma-treated first substrate 20 surface and the second substrate 30 surface with the plasma-treated exposed adhesive strip 40. Illustration IV depicts curing the plasma-treated exposed adhesive strip 40 to form the desired adhesive joint.

In other embodiments, there may be different types of adhesive that do not have liner on both sides thereof. For example, an adhesive on a roll may have liner on only one side. Roll-to-roll techniques are often used in the manufacture and treatment of adhesives and it may be possible to plasma-treat one side of the adhesive during the manufacturing process. Although providing plasma treatment in a roll-to-roll manufacture process provides some efficiency advantages, it may be appropriate only for materials where the adhesive 40 is imminently to be used, or where the decay in surface energy change is very long, for the reasons discussed above with respect to FIG. 2. In those scenarios, illustration II may only involve removing a single backing and treatment of that newly-exposed side with plasma.

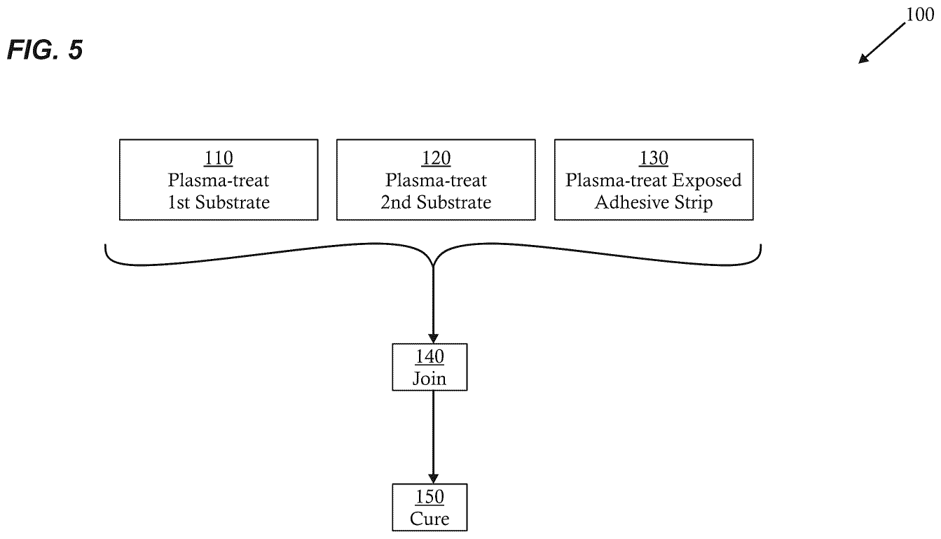

Referring now to FIG. 5, a schematic flow diagram of method 100 is depicted for producing an adhesive joint (e.g., adhesive joint 10). The first substrate can be plasma-treated 110 first, the second substrate can be plasma-treated 120 second, and the top surface and the bottom surface of the exposed adhesive strip can be plasma-treated 130 last, before joining the plasma-treated first substrate surface and plasma-treated second substrate surface together with the plasma-treated exposed adhesive strip 140 and curing the plasma-treated exposed adhesive strip to form the adhesive joint 150. Alternatively, the first substrate can be plasma-treated 110 first, the top surface and the bottom surface of the exposed adhesive strip can be plasma-treated 130 second, and the second substrate can be plasma-treated 120 last, before joining the plasma-treated first substrate surface and plasma-treated second substrate surface together with the plasma-treated exposed adhesive strip 140 and curing the plasma-treated exposed adhesive strip to form the adhesive joint 150. Alternatively, the second substrate can be plasma treated 120 first, the first substrate can be plasma treated 110 second, and the top surface and the bottom surface of the exposed adhesive strip can be plasma-treated 130 last, before joining the plasma-treated first substrate surface and plasma-treated second substrate surface together with the plasma-treated exposed adhesive strip 140 and curing the plasma-treated exposed adhesive strip to form the adhesive joint 150. Alternatively, the second substrate can be plasma treated 120 first, the top surface and the bottom surface of the exposed adhesive strip can be plasma-treated 130 second, and the first substrate can be plasma treated 110 last, before joining the plasma-treated first substrate surface and plasma-treated second substrate surface together with the plasma-treated exposed adhesive strip 140 and curing the plasma-treated exposed adhesive strip to form the adhesive joint 150. Alternatively, the top surface and the bottom surface of the exposed adhesive strip can be plasma-treated 130 first, the first substrate can be plasma treated 110 second, and the second substrate can be plasma-treated 120 last, before joining the plasma-treated first substrate surface and plasma-treated second substrate surface together with the plasma-treated exposed adhesive strip 140 and curing the plasma-treated exposed adhesive strip to form the adhesive joint 150. Alternatively, the top surface and the bottom surface of the exposed adhesive strip can be plasma-treated 130 first, the second substrate can be plasma-treated 120 second, and the first substrate can be plasma treated 110 last, before joining the plasma-treated first substrate surface and plasma-treated second substrate surface together with the plasma-treated exposed adhesive strip 140 and curing the plasma-treated exposed adhesive strip to form the adhesive joint 150. Alternatively, the first substrate can be plasma treated 110 and the second substrate can be plasma-treated 120 simultaneously, and subsequently the top surface and the bottom surface of the exposed adhesive strip can be plasma-treated 130, before joining the plasma-treated first substrate surface and plasma-treated second substrate surface together with the plasma-treated exposed adhesive strip 140 and curing the plasma-treated exposed adhesive strip to form the adhesive joint 150. Alternatively, the first substrate can be plasma treated 110 and the top surface and the bottom surface of the exposed adhesive strip can be plasma-treated 130 simultaneously, and subsequently the second substrate can be plasma-treated 120, before joining the plasma-treated first substrate surface and plasma-treated second substrate surface together with the plasma-treated exposed adhesive strip 140 and curing the plasma-treated exposed adhesive strip to form the adhesive joint 150. Alternatively, the second substrate can be plasma treated 120 and the top surface and the bottom surface of the exposed adhesive strip can be plasma-treated 130 simultaneously, and subsequently the first substrate can be plasma-treated 110, before joining the plasma-treated first substrate surface and plasma-treated second substrate surface together with the plasma-treated exposed adhesive strip 140 and curing the plasma-treated exposed adhesive strip to form the adhesive joint 150.

In other words, the plasma treatments 110, 120, 130 can be performed in any order, or simultaneously. However, it is generally the case that joining 140 occurs prior to the dissipation of the modification to the surface energy that results from the first plasma treatment 110, the second plasma treatment 120, and the third plasma treatment 130, referred to above with respect to FIG. 2.

In addition to being performable in any order in time, the first plasma treatment 110, second plasma treatment 120, and third plasma treatment 130 can be performed at different energy levels relative to one another, based upon a desired level of surface energy modification to be performed. Different materials will have different changes in surface energy level based on interaction with plasma, as described below with respect to various example materials.

Although the description here refers to plasma treatment, it should be understood that other treatments can be performed in parallel with or in lieu of plasma treatment of the various surfaces of adhesive joints. For example, electron beam treatment, ultraviolet treatment, thermal curing, moisture curing, and gamma radiation can be used in concert with the plasma treatments described herein to produce a desired level of cross-linking and surface energy. Plasma treatment has an advantage of primarily affecting the surface of the adhesive material, such that surface energy is modified without creating other changes to the adhesive such as crosslinking. Thus combinations of plasma treatment with these other techniques can be used to provide an adhesive that has a tailored combination of rheological properties and surface energy.

### Adhesive Joints

Disclosed herein are a variety of adhesive joints (e.g., 10) produced via plasma treatment of the various substrate and adhesive surfaces involved at different energy levels. The plasma treatments provided at each surface are tailored to produce a desired surface energy level and level of cross-linking to affect a desired rheological profile that promotes surface wetting and structural integrity without becoming brittle, failing to fully wet across the counterpart surface, or resulting in chain scission or other damage to the materials that make up the substrates and the adhesive.

In this section, adhesive joints are described that are made by the process of plasma treating a first substrate at a first power level to form a plasma-treated first substrate, plasma treating a second substrate at a second power level to form a plasma-treated second substrate, plasma treating a top surface and a bottom surface of an exposed adhesive strip at a third power level to form a plasma-treated exposed adhesive strip, joining the plasma-treated first substrate surface and the plasma-treated second substrate surface together with the plasma-treated exposed adhesive strip, and curing the plasma-treated exposed adhesive strip to produce the adhesive joint. As previously discussed, the plasma treatment of the first substrate at a first power level, the plasma treatment of the second substrate at a second power level, and the plasma treatment of the exposed adhesive strip at a third power level can be performed in any order, or simultaneously, before joining the plasma-treated first substrate surface and the plasma-treated second substrate surface together with the plasma-treated exposed adhesive strip.

The adhesive joint made by the aforementioned process advantageously and unexpectedly displays excellent lap shear strength and resistance to debonding. The process steps impart these specific characteristics to the adhesive joint product.

Also disclosed herein is an adhesive joint made by the process of plasma treating a first substrate at a first power level to form a plasma-treated first substrate surface, plasma treating a second substrate at a second power level to form a plasma-treated second substrate surface, applying a layer of flowable adhesive onto the plasma-treated second substrate surface and plasma treating the layer of flowable adhesive at a third power level to form a plasma-treated layer of flowable adhesive, joining the plasma-treated first substrate surface with the plasma-treated layer of flowable adhesive positioned on the plasma-treated second substrate surface, and curing the plasma-treated layer of flowable adhesive to produce the adhesive joint. Notably, the plasma treatment of the first substrate at a first power level and the plasma treatment of the second substrate at a second power level can be formed in any order, or simultaneously, before applying a layer of flowable adhesive onto the plasma-treated second substrate surface.

Consistent with an aspect, the layer of flowable adhesive can comprise, but is not limited to, at least one epoxy resin, at least one curing agent, and/or at least one additive. Any suitable epoxy resin, curing agent, and/or additive can be present in the flowable adhesive. In a non-limiting aspect, the at least one epoxy resin in the flowable adhesive is a phenol-formaldehyde polymer with glycidyl ether, bisphenol A-epoxy resin, diglycidylether-bisphenol A (DGEBA), an acrylic polymer, and/or any combination thereof. In another non-limiting aspect, the at least one curing agent in the flowable adhesive is dicyandiamide (DICY), ethylenediamine, triethylenetetramine, diethylenetriamine, phthalic anhydride, maleic anhydride, and/or any combination thereof. In a particular aspect, the at least one curing agent in the flowable adhesive is dicyandiamide (DICY). In yet another non-limiting aspect, the at least one additive in the flowable adhesive is a filler, plasticizer, stabilizer, tackifier, cross-linking agent, solvent, colorant, and/or any combination thereof.

A layer of flowable adhesive is applied onto the plasma-treated second substrate surface and the adhesive is plasma treated at a third power level to form a plasma-treated layer of flowable adhesive. In some embodiments, the flowable adhesive is dispensed from a tube with a nozzle. The flowable adhesive can be applied onto the area of the plasma-treated second substrate surface that previously received plasma treatment (i.e., the bonding area of the plasma-treated second substrate). In an aspect, the flowable adhesive is in the form or a liquid and/or a paste.

Any suitable plasma generator or reactor can be utilized to plasma-treat the layer of flowable adhesive. The plasma generator or reactor used for plasma treating the layer of flowable adhesive can be a low-power expanded plasma cleaner with an adjustable radio frequency setting. In an aspect, a gas or mixture of gases is introduced into the plasma generator or reactor. In a particular aspect, the gas or mixture of gases introduced into the plasma generator or reactor comprises oxygen and/or argon. In a particular aspect, a gaseous mixture of oxygen and argon is introduced into the plasma generator or reactor for plasma treating layer of flowable adhesive.

The plasma treatments at the first and second power levels for the first and second substrate surfaces previously discussed can easily cause the flowable adhesive to crosslink due to the high temperatures generated by the plasma. Thus, consistent with an aspect, the first power level and the second power level (used for plasma treating the first and second substrates) are higher than the third power level.

In an aspect, the third power level generates enough plasma energy to activate the functional groups on the surface of the flowable adhesive. Generally, the functional groups activated on the surface of the flowable adhesive, through plasma treatment, can include, but are not limited to, epoxy groups, carbonyl groups, nitrile groups, amine groups, hydroxyl groups, and/or any combination thereof. However, as one of skilled in the art would readily recognize, the types of functional groups activated on the flowable adhesive surface depend on many factors, including the type of flowable adhesive utilized and other processing parameters.

The third power level of the plasma reactor can be controlled to regulate the energy supplied to the plasma and achieve the desired surface modifications without damaging the flowable adhesive. When the third power level is too high, it can induce crosslinking and/or chain scission within flowable adhesive. This can reduce the adhesive's effectiveness for subsequent bonding. Thus, consistent with an aspect, the third power level generates a controlled amount of plasma energy to prevent cross-linking and/or chain scission within the flowable adhesive.

The flowable adhesive can be plasma-treated for any suitable period of time. In general, the flowable adhesive surface can be plasma-treated for a period of time sufficient to activate the functional groups on the surface. In a particular, non-limiting aspect, the surface of the flowable adhesive is plasma-treated for 10 minutes.

During plasma treatment, the surface of flowable adhesive are exposed to energetic particles and radicals generated in the plasma. These species can break chemical bonds on the aforementioned surfaces and create new functional groups. The chemical bond density refers to the density of these newly created functional groups per unit area of the surface. Thus, consistent with an aspect, the chemical bond density at the surface of the plasma-treated flowable adhesive is greater than the chemical bond density at the surface of the flowable adhesive before plasma treatment.

The plasma-treated first substrate is joined with the plasma-treated layer of flowable adhesive positioned on the plasma-treated second substrate surface to form a bonded region. Typically, the plasma-treated layer of flowable adhesive is utilized for joining the substrates together shortly after being plasma-treated, as its enhanced surface energy is time-sensitive. Usually, the plasma-treated first substrate surface is joined together with the plasma-treated layer of flowable adhesive positioned on the plasma-treated second substrate surface under pressure. Any suitable amount of pressure may be applied to join the plasma-treated first substrate surface and the with the plasma-treated layer of flowable adhesive positioned on the plasma-treated second substrate surface together to create the bonded region.

After joining the plasma-treated first substrate surface with the plasma-treated layer of flowable adhesive positioned on the plasma-treated second substrate surface, the plasma-treated layer of flowable adhesive is cured to produce the adhesive joint. The plasma-treated layer of flowable adhesive can be cured using any suitable method. Suitable curing methods include, but are not limited to, thermal curing, UV curing, and/or electron beam curing. As one of skilled in the art would readily recognize, the choice of curing method may depend on the nature and composition of the adhesive and/or substrates. In a particular aspect, the plasma-treated layer of flowable adhesive is cured in a conventional oven at 150° C.

Additionally, the plasma-treated layer of flowable adhesive can be cured for any suitable period of time. In general, the plasma-treated layer of flowable adhesive can be cured for a period of time sufficient to cure the plasma-treated layer of flowable adhesive. In a particular, non-limiting aspect, the plasma-treated layer of flowable adhesive is cured for 45 minutes to form the adhesive joint.

The adhesive joints disclosed herein, comprising the plasma-treated first substrate surface and the plasma-treated second substrate surface joined together with the plasma-treated layer of flowable adhesive, unexpectedly display exceptional lap shear strength and resistance to debonding. Thus, in accordance with an aspect, the lap shear strength of the adhesive joint is greater than the lap shear strength of an adhesive joint in which the layer of flowable adhesive was not plasma-treated.

The unexpected lap shear strength and resistance to debonding of the adhesive joints can be attributed to the formation of a denser network of intra-molecular bonds between the substrates and layer of flowable adhesive. In a non-limiting example, plasma treatment on the first and second substrate surfaces can active more hydroxyl groups, and plasma treatment of the flowable adhesive surfaces can activate epoxy groups. As a result, the activated hydroxyl groups on the substrate surfaces initiate the opening of the epoxy rings on the flowable adhesive surfaces and form covalent bonds. This polymerization process further leads to the formation of cross-linked bonds at the substrate/adhesive interfaces. The formation of a denser cross-linked network of covalent bonds formed due to the hydroxyl-initiated epoxy ring opening polymerization is particularly important for an adhesive joint with a polymer/adhesive interface to make this interface more resistance to debonding.

Additionally, plasma-induced physical changes of interfacial microstructural features also contribute to the unexpected lap shear strength and resistance to debonding of the adhesive joints. For the adhesive joints, a decrease in interfacial void area fraction at substrate/adhesive interfaces can be observed when both the substrates and adhesive are plasma-treated. Thus, in an aspect, the interfacial void area fraction (V_{if}) percentage of interfacial voids between the plasma-treated layer of flowable adhesive and the plasma-treated first substrate is less than the interfacial void area fraction (V_{if}) percentage of an adhesive joint in which the layer of flowable adhesive is not plasma-treated. Beneficially, the decreased interfacial void area fraction can mitigate the stress concentration among interfacial voids, and reduce the negative effect of the interfacial voids at the substrate/adhesive interface on the lap shear behavior.

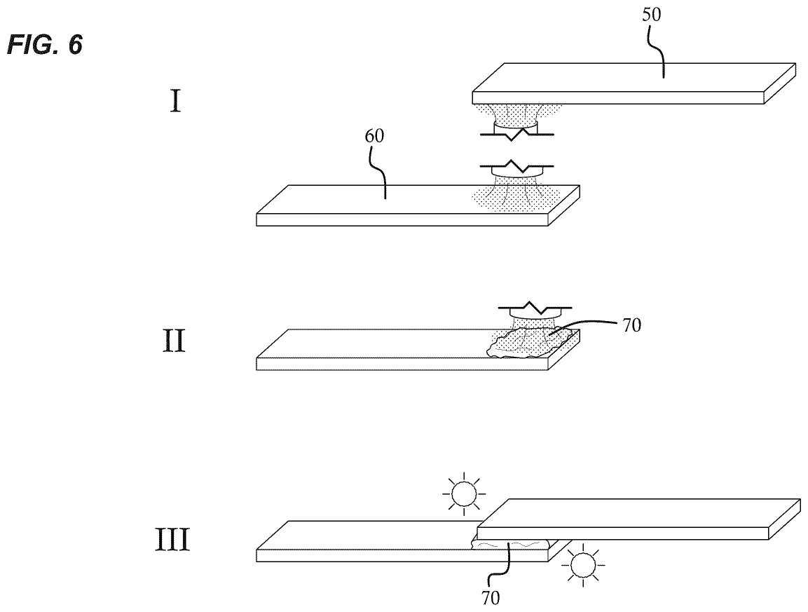

Referring now to FIG. 6, a schematic flow diagram illustrates a method for producing an adhesive joint. Illustration I depicts plasma treating the first substrate 50 and the second substrate 60. Illustration II depicts applying a layer of the flowable adhesive onto the plasma-treated second substrate surface 60 and plasma-treating the layer of flowable adhesive 70. Illustration III depicts joining the plasma-treated first substrate 50 surface with the plasma-treated layer of flowable adhesive 70 positioned on the plasma-treated second substrate 60 surface, and curing the plasma-treated layer of flowable adhesive 70 to form the desired adhesive joint.

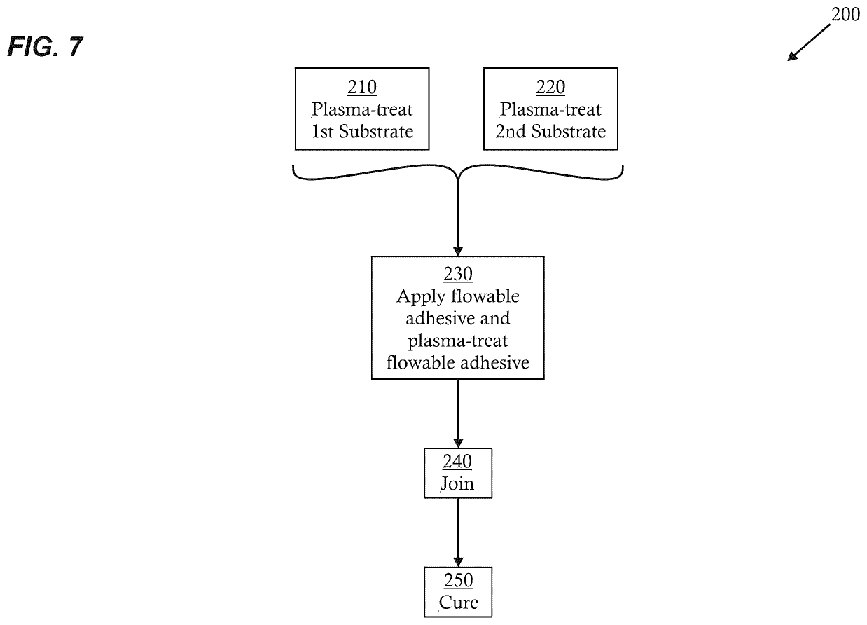

Referring now to FIG. 7, which illustrates a schematic flow diagram of method 200 for producing an adhesive joint. The first substrate can be plasma-treated 210 first, the second substrate can be plasma-treated 220 second, before applying a layer of the flowable adhesive onto the plasma-treated second substrate surface and plasma treating the layer of flowable adhesive 230, joining the plasma-treated first substrate surface with the plasma-treated layer of flowable adhesive positioned on the plasma-treated second substrate surface 240, and curing the plasma-treated layer of flowable adhesive to produce the adhesive joint 250. Alternatively, the second substrate can be plasma-treated 220 first, the first substrate can be plasma-treated 210 second, before applying a layer of the flowable adhesive onto the plasma-treated second substrate surface and plasma treating the layer of flowable adhesive 230, joining the plasma-treated first substrate surface with the plasma-treated layer of flowable adhesive positioned on the plasma-treated second substrate surface 240, and curing the plasma-treated layer of flowable adhesive to produce the adhesive joint 250.

### EXAMPLES

The invention is further illustrated by the following examples. Various other aspects, modifications, and equivalents thereof which, after reading the description herein, can suggest themselves to one of ordinary skill in the art without departing from the spirit of the present invention or the scope of the appended claims.

In these examples, surface energy was determined using the Owns, Wendt, Rabel, and Kaelble (OWRK) method, which allows for the calculation of the polar and dispersive components of the material surface free energy. In this method, the contact angles of two testing liquid drops (water and diiodomethane) on adherends and adhesive tape were measured before and after plasma treatment using a KR″USS mobile surface energy analyzer with an advanced software (KR″USS Scientific Instruments, Matthews, NC, USA). The OWRK method utilizes the known polar and dispersive surface free energies of water and diiodomethane to calculate the unknown components of the material surface free energy. To ensure accuracy and reliability, five reproducible measurements were conducted for each sample detailed below.

For the quasi-static single lap sheer tests, ASTM D1002 and D5868 procedure (designed for single lap shear joints with similar materials) was utilized. The lap shear strength of the joints was determined by defining the nominal or lap shear strength as τs=Fpeak/Abond, where Fpeak represents the peak load and Abond is the bonded area.

The FTIR spectra were collected using the Attenuated Total Reflectance (ATR) absorbance mode of a Thermo Scientific Nicolet™ iS™ 10 FTIR Spectrometer, which was equipped with a diamond crystal ATR attachment. The spectra were measured in the range of 4000-500 cm⁻¹ with a resolution of 0.482 cm⁻¹ and 128 scans were performed for each data point.

XPS measurements were conducted using a Physical Electronics Quantera Scanning X-ray Microprobe (SXM). This system utilized a focused monochromatic A1 Kα X-ray source (1486.7 eV) for excitation and a spherical section analyzer. The instrument was equipped with a 32-element multichannel detection system.

High energy resolution spectra were collected with a pass-energy of 69.0 eV and a step size of 0.125 eV. The binding energy (BE) scale is calibrated using the Cu 2p3/2 feature at 932.62±0.05 CV and the Au 4f7/2 feature at 83.96±0.05 eV. To minimize sample charging during analysis, low energy electrons at approximately 1 eV and 20 μA, along with low energy Ar+ ions, were employed. The binding energy was charge-corrected by referencing the primary C1s line at 284.8 eV. Quantification was performed using the Origin software program for the analysis of the selected narrow scan spectra for each sample, which involved baseline correction and curve fitting.

The physical surface topology before and after conducting plasma treatment and single lap shear testing was measured using a Keyence VR-5000 3D optical profilometer (Keyence Co., Itasca, IL, USA). The surface was scanned in approximately 50 sections at a magnification of 32×, and the complete surface profile of the bonded region was generated by stitching all the scanned sections together. Surface roughness was analyzed using a multi-line technique, specifically employing 1100 lines with an interval of about 10 pixels. Additionally, other surface characteristics such as interfacial voids and adhesive distribution after failure were also analyzed using the Keyence software.

Disclosed are methods for preparing adhesive joints, and specifically, methods for preparing adhesive joints in which the dissimilar substrates and adhesive are plasma-treated. Advantageously, the adhesive joints prepared by the disclosed methods display exceptional lap shear behavior and resistance to interfacial debonding.

### Materials

The first substrate was a 40 wt. % randomly distributed short carbon-fiber-reinforced polyphthalamide (CFRPPA) fabricated through injection molding from BASF (Cumming, GA, USA). The second substrate was an aluminum alloy (AA6061), purchased from McMaster-Carr (Robbinville, NJ USA). The adhesive was a tape-type thermoset adhesive with black color (PX5005F) from L & L Products (Romeo, MI, USA) which contained epoxy polymers (phenol-formaldehyde polymer with glycidyl ether, bisphenol A-epoxy resin, diglycidylether-bisphenol A (DGEBA), and acrylic copolymer), dicyandiamide (DICY) as the curing agent, and some additives (vendor's proprietary agents). An alternative adhesive was a paste-type thermoset adhesive (XP0012) from L & L Products (Romeo, MI, USA) which contained epoxy polymers (phenol-formaldehyde polymer with glycidyl ether, bisphenol A-epichlorohydrin polymer, and diglycidylether-bisphenol A (DGEBA)), dicyandiamide (DICY) as the curing agent, and some additives.

### Plasma Treatments

Plasma treatment was performed on the CFRPPA surface, on the AA6061 surface, and on the top and bottom surfaces of the PX5005F adhesive for Inventive Example 1. For Inventive Example 2, the CFRPPA and AA6061 surfaces were plasma-treated, the XP0012 adhesive paste was spread onto the plasma-treated surface of the AA6061, and the XP0012 adhesive paste was plasma-treated. For Inventive Examples 1-2, a 500 W Blown-Ion plasma system (Enercon Ind Co, Menomonee Falls, WI, USA) with compressed air as the gas source was used for the plasma treatment of the CFRPPA and AA6061 surfaces. The plasma treatment was applied exclusively to the area of the CFRPPA and AA6061 surfaces that will be bonded. Before conducting the plasma treatments, the AA6061 surface was wiped with acetone and cleaned using a scouring pad, while the CFRPPA surface was used as-received without additional abrasion.

The CFRPPA and AA6061 surfaces were plasma-treated with the following parameters to enhance the interfacial bonding density and optimize surface energy and wettability for the possible reduction of air voids at the interface of substrate and adhesive. A combination of treatment parameters was utilized for the plasma treatment of the AA6061 surface including: a nozzle tip end to surface distance (d) of 6.4 mm, a nozzle tip speed (v) of 3.2 mm/s, a step-over distance (so) of 9 mm, and a gas pressure (p) of 85 psi. For the CFRPPA surface, the plasma treatment speed was chosen to be much higher than the one used for AA6061 to avoid the thermal effect (i.e., melting or degradation of thermoplastic polymer on the CFRPPA surface) coupled with the plasma effect (i.e., activation of surface chemistry), thus leading to treatment parameters including: a nozzle tip end to surface distance (d) of 3 mm, a nozzle tip speed (v) of 100 mm/s, a step-over distance (so) of 9 mm, and a gas pressure (p) of 75 psi.

For Inventive Examples 1-2, a low-power expanded plasma cleaner with an adjustable radio frequency setting (Harrick Plasma, Ithaca, NY) was used for the plasma treatment of PX5005F and XP0012. First, a backing on the PX5005F adhesive was removed, to provide an exposed PX5005F adhesive strip (the top and bottom surfaces of the PX5005F were exposed). A layer of the XP0012 was applied to the plasma-treated AA6061 surface (i.e., the bonding area). Both the top and bottom surfaces of the exposed PX5005F adhesive strip and the surface layer of the XP0012 were plasma-treated for 10 minutes by using a mix of 14% oxygen and 86% argon gases under a pressure of 550 mTorr and an output power of 45 W. Specifically, for the PX5005F adhesive, the plasma treatment time was determined by optimizing the surface energy of the adhesive tape surface. As shown in FIG. 8, which illustrates a plot of the surface energy of the PX5005F adhesive surface as a function of plasma treatment time, the total surface energy of the adhesive tape surface almost reached a plateau after a 10-minute plasma treatment. Thus, a 10-minute plasma treatment time was determined to be most favorable for the top and bottom surfaces of the PX5005F adhesive tape.

### Surface Energy

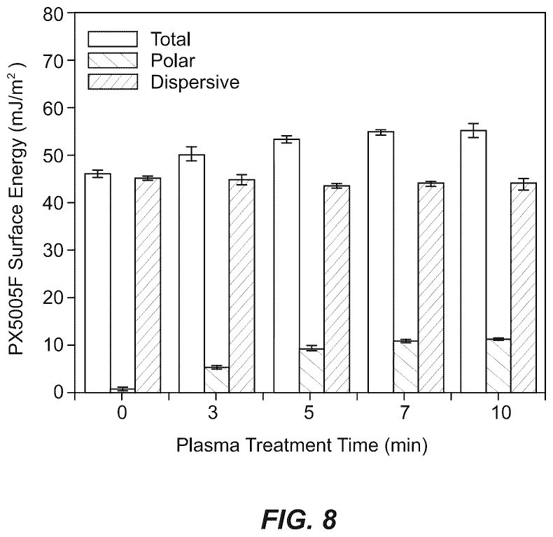

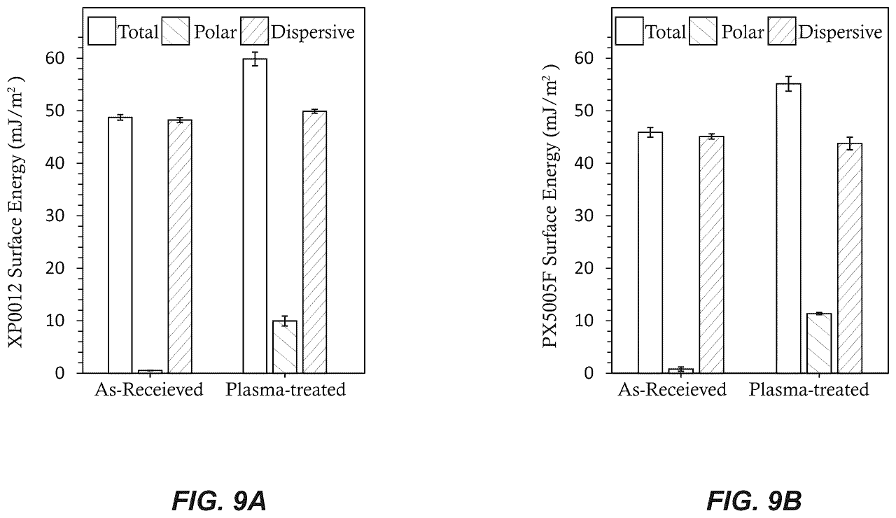

The plasma treatment of the substrates and adhesives can significantly impact their surface energies. The surface energies of the as-received XP0012 adhesive paste and the plasma-treated XP0012 adhesive paste were investigated and compared in FIG. 9A. As shown in FIG. 9A, a 22% increase in the polar component of surface energy was observed after plasma treatment of the XP0012 adhesive paste. Likewise, the surface energies of the as-received PX5005F adhesive tape and the plasma-treated PX5005F adhesive tape were investigated and compared in FIG. 9B. As shown in FIG. 9B, a 20.1% increase in the polar component of surface energy was observed after plasma treatment of the PX5005F adhesive. The large polar component in the XP0012 and PX5005F adhesive surface energies indicated strong polarity at the adhesive surfaces after plasma treatment.

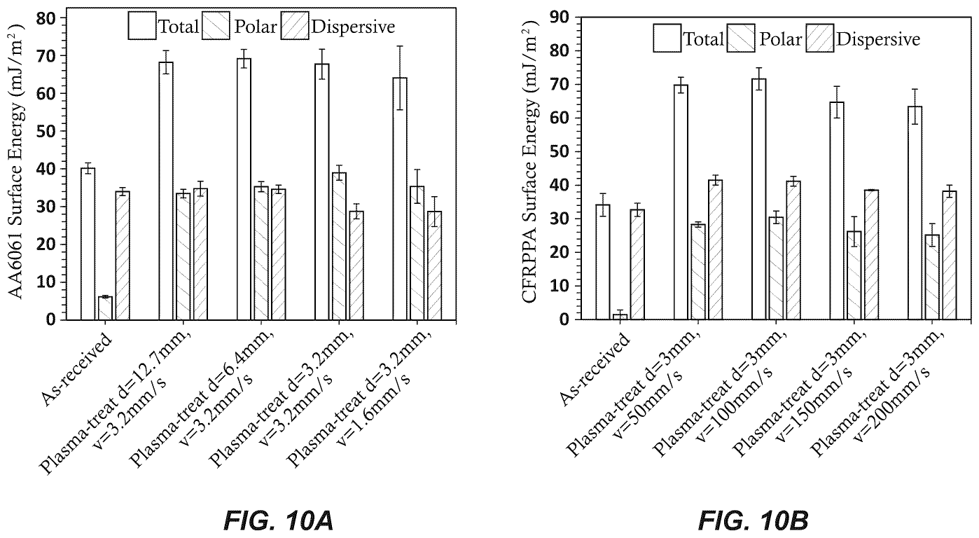

The surface energies at different plasma treatment parameters of the as-received AA6061 surface and the plasma-treated AA6061 surface were investigated and compared in FIG. 10A. As shown in FIG. 10A, an increase in the polar component of surface energy was observed after plasma treatment of the AA6061 surface. Likewise, the surface energies at different plasma treatment parameters of the as-received CFRPPA surface and the plasma-treated CFRPPA surface are compared in FIG. 10B. As shown in FIG. 10B, an increase in the polar component of surface energy was observed after plasma treatment of the CFRPPA surface.

### ATR-FTIR Analysis

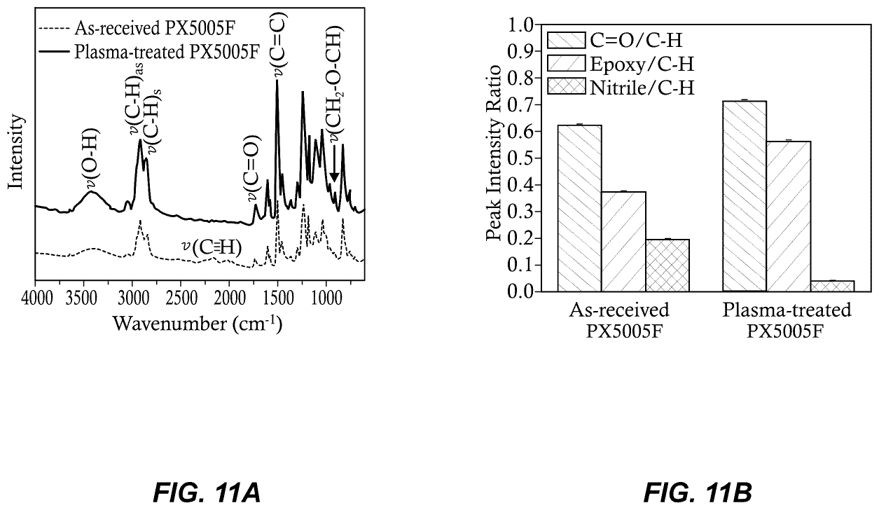

ATR-FTIR analysis was conducted on both the adhesives and CFRPPA surfaces to evaluate the differences in surface chemistry before and after plasma treatment. For the PX5005F adhesive, FIG. 11A displays the ATR-FTIR spectrums for both the as-received and plasma-treated conditions. In this figure, the plasma-treated PX5005F adhesive tape shows changes in the intensities of certain vibrational peaks of chemical bonds compared to the non-treated counterparts, whereas peak locations of the PX5005F adhesive tape do not significantly change after plasma treatment. More specifically, the intensity ratios of the carbonyl (1727 cm-1), epoxy (913 cm⁻¹), and nitrile (2159 cm⁻¹) peaks to the stable C—H stretching vibration (2856 cm⁻¹) before and after plasma treatment were calculated with baseline correction for comparison.

As shown in FIG. 11B, which illustrates a plot of the peak intensity ratios for the as-received and plasma-treated PX5005F adhesive, the carbonyl and epoxy peak ratios increased by 14.7% and 50.9%, respectively, after plasma treatment. However, the nitrile peak ratio decreased significantly by 98.5%. This indicates that a chemical reaction occurred in the nitrile groups of the PX5005F adhesive tape surface during the plasma treatment.

Furthermore, the ratio of hydrated carbonyl (˜1720 cm⁻¹) to combined monomeric (˜1738 cm⁻¹) and hydrated carbonyls for the plasma-treated PX5005F adhesive was compared with that of the non-treated PX5005F adhesive. Carbonyl groups of PX5005F adhesive were de-convoluted after correcting the baseline to deduce the amount of carbonyl groups at different wavenumbers. Two carbonyl peaks were observed at 1738.9 and 1720.4 cm-1 before plasma treatment of the PX5005F adhesive, whereas the plasma treatment led to a slight moving of the two carbonyl peaks to lower wavenumbers, 1735.0 and 1719.7 cm⁻¹. Based on the calculation of the areas under the carbonyl peaks, the amount of hydrated carbonyl peaks increased from 32% to 41.1% after the plasma treatment of the PX5005F adhesive, confirming the enhanced polar component of surface energy on the PX5005F adhesive due to plasma treatment.

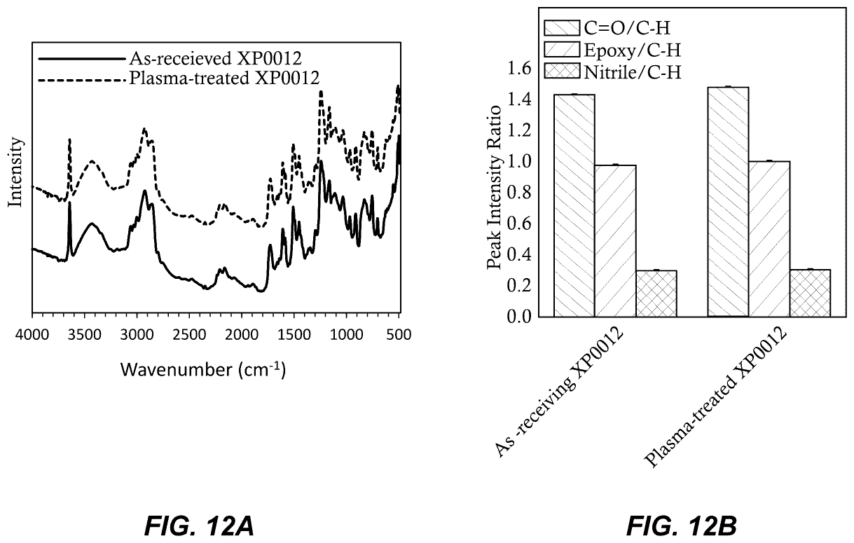

For the XP0012 adhesive, FIG. 12A displays the ATR-FTIR spectrum for both the as-received and plasma-treated conditions. In this figure, the plasma-treated XP0012 adhesive paste shows minor changes in the intensities of certain vibrational peaks of chemical bonds compared to the non-treated XP0012, whereas peak locations of the XP0012 adhesive paste do not significantly change after plasma treatment. More specifically, the intensity ratios of the carbonyl (1727 cm⁻¹), epoxy (913 cm⁻¹), and nitrile (2159 cm⁻¹) peaks to the stable C—H stretching vibration (2856 cm⁻¹) before and after plasma treatment were calculated with baseline correction for comparison. As shown in FIG. 12B, the carbonyl, epoxy, and nitrile peak ratios increased by 2.1%, 3.1%, and 4.2% respectively, after plasma treatment.

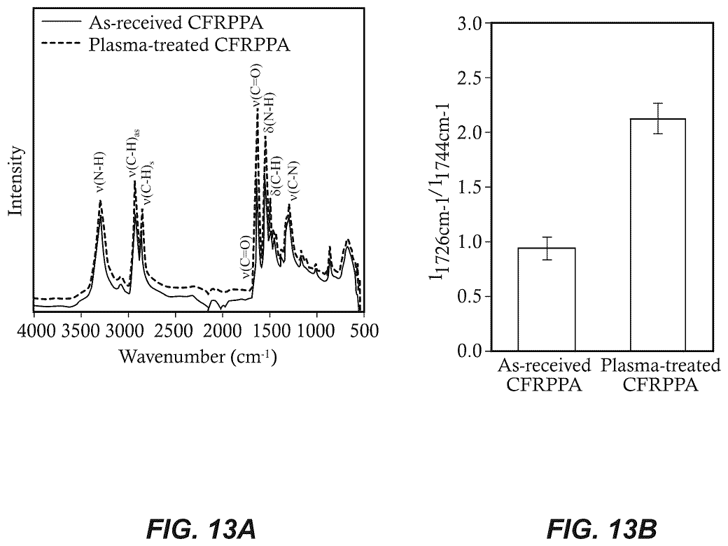

Regarding the CFRPPA surface, the ATR-FTIR spectrum of the plasma-treated CFRPPA was compared with that of the as-received CFRPPA. As shown in FIG. 13A, plasma surface modification with the investigated parameters did not noticeably alter the vibrational frequencies of the functional groups on the surface of CFRPPA. The intensities of two vibrational peaks (hydrated carbonyl at 1726 cm⁻¹ and monomeric carbonyl at 1744 cm⁻¹) before and after plasma treatment were further analyzed. The average peak intensity ratio of 1726 cm⁻¹ to 1744 cm⁻¹ for as-received CFRPPA was 0.94, but it increased up to 2.13 after the plasma treatment, as shown in FIG. 13B. This indicates that air plasma treatment activated more surface carbonyl groups on the surface of CFRPPA than those on the as-received CFRPPA surface.

### XPS Analysis

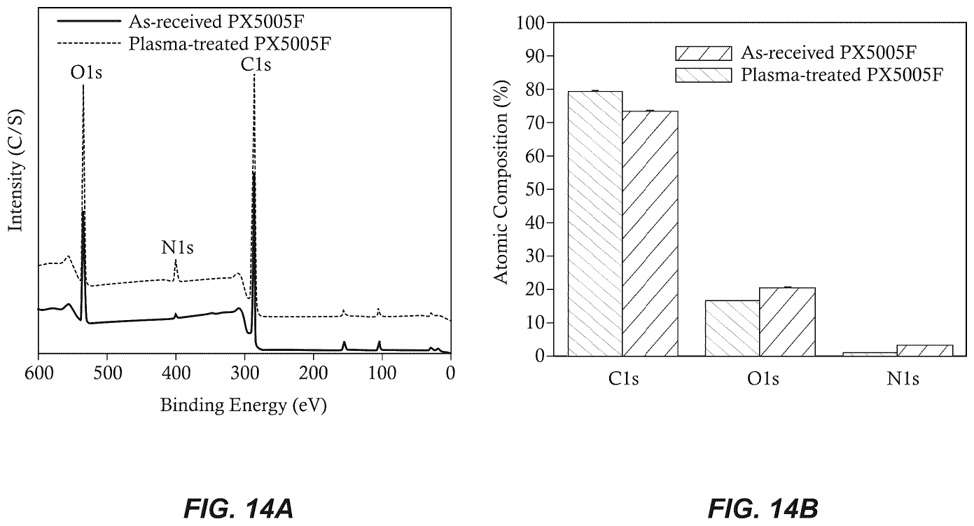

To supplement the foregoing ATR-FTIR results, both the as-received and plasma-treated PX5005F adhesive tape and XP0012 adhesive paste were further analyzed by XPS. In the wide scan XPS spectra for the PX5005F adhesive tape, mainly three atoms were detected, namely O1s, N1s, and C1s, at energy levels of 533.58, 401.08, and 285.08 eV, respectively, as shown in FIG. 14A. It should be noted that an approximately 2.5% silicon impurity was also detected on the adhesive tape surface. The atomic composition obtained from the XPS results showed an increase in oxygen (from 16.7% to 20.5%) and nitrogen (from 1.1% to 3.5%), while carbon content decreased from 79.3% to 73.3% after plasma surface modification of the PX5005F adhesive tape, as shown in the FIG. 14B plot. This is consistent with the vibrational spectroscopic results showing more hydroxyl, carbonyl, and epoxy groups of plasma-treated adhesive tape surface (FIGS. 11A and 11B). An increase in N1s composition after plasma modification of the PX5005F adhesive tape indicates the exposure of amine and nitrile functional groups of dicyandiamide. These smallest hydrophilic molecules present in the adhesive can migrate to the surface during the plasma surface treatment.

Moreover, two atoms (C1s and O1s) were analyzed by high resolution XPS scans for the as-received and plasma-treated PX5005F adhesive. For the C1s spectra, a 1.1% of carboxylate group was detected on the plasma-treated PX5005F adhesive surface, and a higher presence of oxidized carbon (C—O) compared to the as-received PX5005F was also observed. For the O1s spectra, the non-carbonyl oxygen on the as-received PX5005F adhesive was transformed into 6.5% carbonyl oxygen after the plasma treatment. These high-resolution XPS results further support the ATR-FTIR results, indicating a higher oxidation level of the PX5005F adhesive tape surface after plasma treatment.

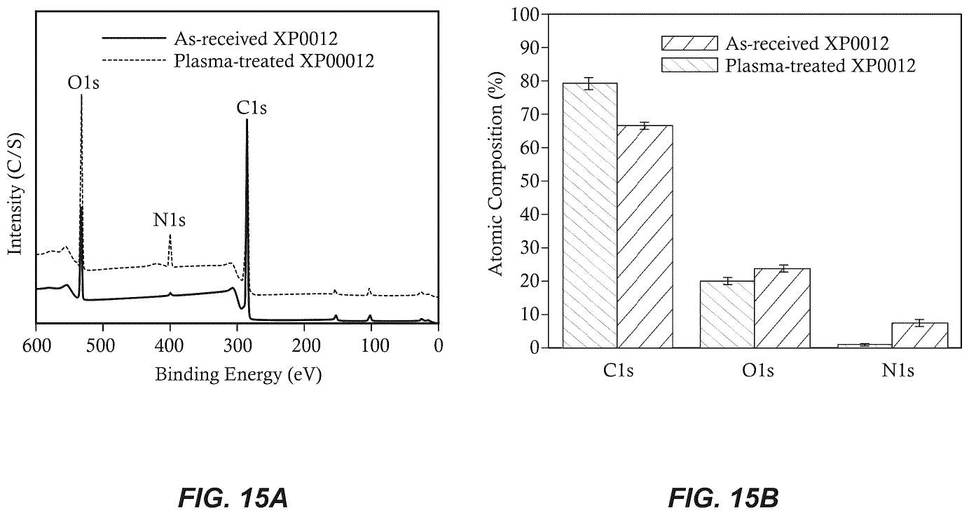

In the wide scan XPS spectra for the XP0012 adhesive paste, mainly three atoms were detected, namely O1s, N1s, and C1s, at energy levels of 533.58, 401.08, and 285.08 eV, respectively, as shown in FIG. 15A. The atomic composition obtained from the XPS results showed an increase in oxygen (from 19.5% to 22.1%) and nitrogen (from 0.50% to 6.9%), while carbon content decreased from 78.4% to 66.5% after plasma surface modification of the XP0012 adhesive paste, as shown in FIG. 15B. The large increase in N1s composition after plasma modification of the XP0012 adhesive paste indicates the exposure of amine and nitrile functional groups of dicyandiamide. These smallest hydrophilic molecules present in the adhesive can migrate to the surface during the plasma surface treatment.

Moreover, three atoms (C1s, O1s, and N1s) were analyzed by high resolution XPS scans for the as-received and plasma-treated XP0012 adhesive. For the C1s spectra, a 1.1% of carboxylate group was detected on the plasma-treated XP0012 adhesive surface, and a higher presence of oxidized carbon (C—O) compared to the as-received XP0012 was also observed. For the N1s spectra, a 16.1% of imine group was detected on the plasma-treated XP0012 adhesive surface. For the O1s spectra, the non-carbonyl oxygen on the as-received XP0012 adhesive was transformed into 9.5% carbonyl oxygen after the plasma treatment.

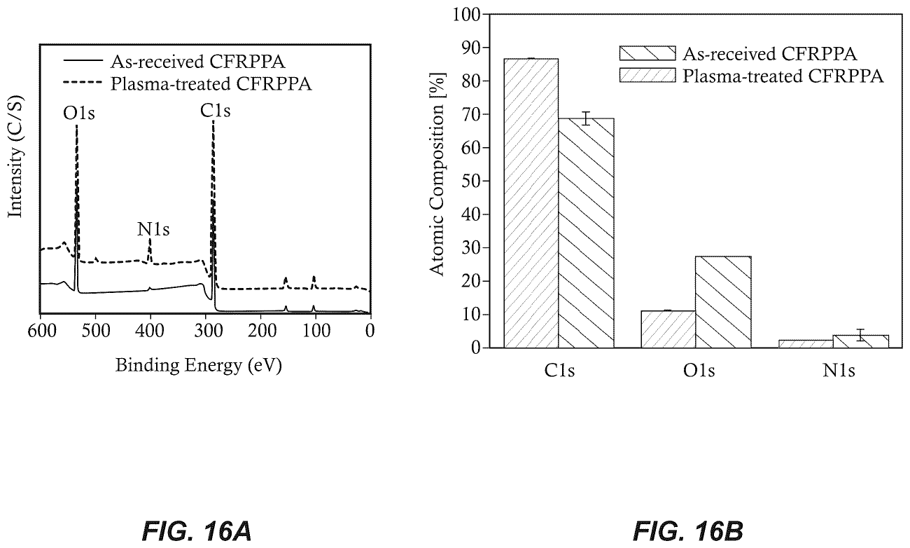

XPS measurements were further performed on the CFRPPA surface before and after plasma surface treatment. In the wide scan XPS spectra for the CFRPPA, mainly three atoms were detected, namely O1s, N1s, and C1s, at energy levels of 533.58, 401.08, and 285.08 eV, respectively, as shown in FIG. 16A. As shown in the FIG. 16B plot, for the wide scan XPS spectra and atomic composition, the air plasma treatment led to a significant increase in oxygen content (from 10.9% to 24.7%) and a slight increase in nitrogen content (from 2.2% to 3.7%), indicating the possible exposure of amide groups on CFRPPA surface after plasma treatment. Additionally, the XPS results showed an 18% decrease in carbon content after plasma treatment, along with the detection of approximately 2% silicon impurity.

Moreover, high resolution XPS plots for three atoms (C1s, O1s, and N1s) were obtained for the CFRPPA substrate. For the C1s spectra, the content of surface carbon backbone (C—C/C—H) decreased by approximately 16%, while the fractions of C—N/C—O increased from 3.8% to 9.3%, and N—C═O/C(═O)—O increased from 7.8% to 18%. For the O1s spectra, the low degree of oxidation (C—O) of as-received CFRPPA increased from 1.9% to 9.3% after plasma treatment. For the N1s spectra, a 3% higher presence of amide nitrogen (N—C═O) was observed after plasma treatment compared to that of as-received CFRPPA, while a small amount of pyridine-type nitrogen (1.1%) was also detected. These high-resolution XPS results confirmed a higher oxidation level of the CFRPPA surface after plasma treatment.

### Single Lap Shear Tests

Comparative examples utilizing the tape-type adhesive were designed to assess the differences relative to Inventive Example 1, where the CFRPPA surface, the AA6061 surface, and the top and bottom surfaces of the PX5005F adhesive were plasma-treated, as shown in Table I. For Comparative Example A, plasma treatments were performed on the CFRPPA and AA6061 surfaces, as described above, but the PX5005F adhesive was not plasma treated, as shown in Table I. For Comparative Example B, no plasma treatments were performed on the CFRPPA surface, the AA6061 surface, or the PX5005F tape, respectively, as shown in Table I.

Single-lap-joint specimens were formed by: (1) joining the plasma-treated CFRPPA and the plasma-treated AA6061 surfaces together with the plasma-treated PX5005F adhesive (Inventive Example 1), (2) joining the plasma-treated CFRPPA and the plasma-treated AA6061 surfaces together with the non-plasma-treated PX5005F adhesive (Comparative Example A), and (3) joining the non-plasma-treated CFRPPA and the non-plasma-treated AA6061 surfaces together with the non-plasma-treated PX5005F adhesive (Comparative Example B). Three specimens for each scenario were prepared to measure to the deviation of the results. For all of the single-lap-joint specimens, the dimensions of both the AA6061 and CFRPPA substrates were 25.4×101.6×3 mm, and the bonded area of the joints was 25.4 mm×25.4 mm. The PX5005F adhesive in the joints was cured in a conventional oven at 150° C. for 45 minutes, and the bond line thickness was approximately 200 μm for all of the single-lap-joint specimens. After removing the joints from the oven, any excess adhesive that flowed out during the bonding process outside of the bonded area was gently removed using a utility knife.

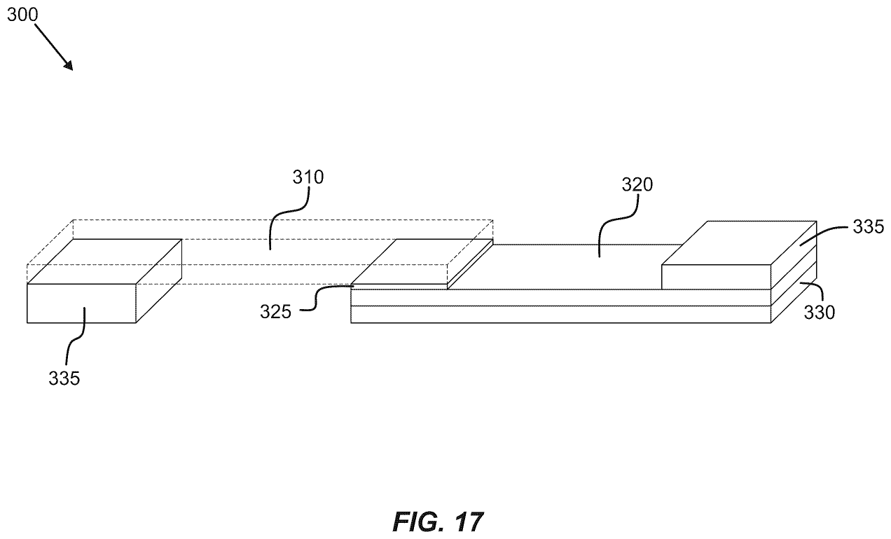

The prepared single-lap-joint specimens were subjected to quasi-static single lap shear tests to evaluate lap shear strength of the joints. The quasi-static single lap shear tests were performed on a servo-hydraulic MTS 312.21 load frame under displacement control with a displacement rate of 1.27 mm/min. FIG. 17 illustrates the single-lap-joint specimen setup 300 for the single lap shear tests of Inventive Example 1 with the AA6061 substrate 310 bonded to the CFRPPA substrate 320 with the PX5005F adhesive 325. As shown in FIG. 17, to prevent the fracture of the CFRPPA substrate prior to adhesive failure, an additional AA6061 substrate 330 was bonded to the backside of the CFRPPA substrate on the specimens. Additionally, in order to facilitate the application of displacement and minimize load eccentricity during the single lap shear tests, alignment tabs 335 were taped onto the specimens, as illustrated in FIG. 17.

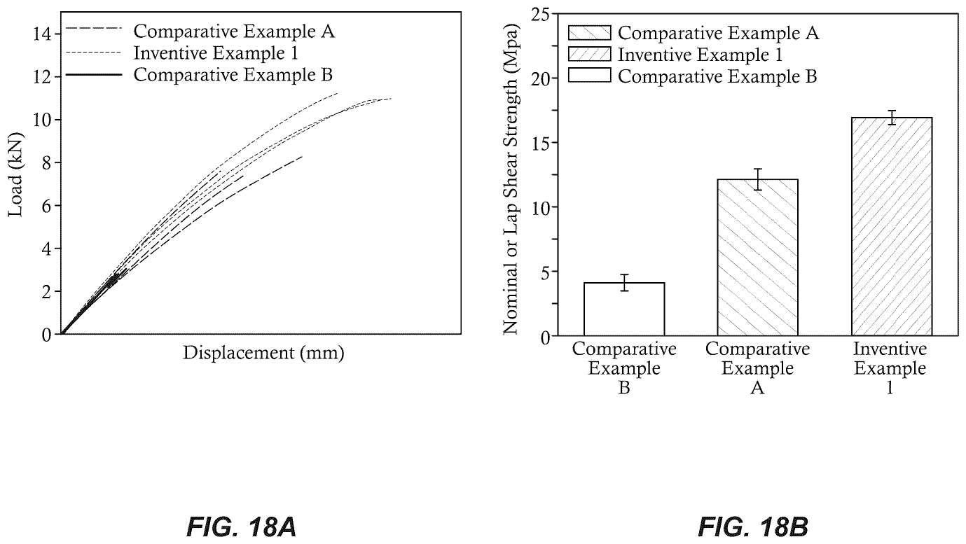

The load-displacement curves obtained from the single lap shear tests on Inventive Example 1 and Comparative Examples A-B AA6061-CFRPPA joints are plotted in FIG. 18A. For Comparative Example B, the mechanical behavior of the joints displayed linearity up to the peak load. This linearity indicates that the failure mode primarily involves substrate/adhesive interfacial debonding, resulting in brittle failure without significant plastic deformation and damage to the adhesive and adherends.

However, for Comparative Example A, the mechanical behavior of the joints exhibited a significant improvement and started to show slight non-linearity before reaching the peak load, as shown in FIG. 18A. As shown in the FIG. 18B plot and Table I, the average lap sheer strength (τs) of the Comparative Example A joints was 12.2 MPa, with the improvement in average τs reaching up to approximately 200% compared to that of the Comparative Example B joints, which had an average τs of 4.1 MPa. The foregoing non-linearity implies additional deformation and failure modes occurring in the Comparative Example A joints before catastrophic failure due to plasma-treated substrates.

Notably, as shown in FIG. 18A, the non-linearity in the mechanical behavior of single lap shear joints became even more significant when both the top and bottom surfaces of the PX5005F adhesive were plasma-treated in addition to the plasma treatment of CFRPPA and AA6061 substrate surfaces (Inventive Example 1 joints). Such a non-linear behavior can be caused by the damage in PX5005F adhesive and CFRPPA adherend, as well as non-negligible plastic deformation of the AA6061 adherend in a AA6061-CFRTP dissimilar joint due to the load-eccentricity-induced bending near the bonded region. Consequently, as shown in FIG. 18B and Table I, the average τs of the Inventive Example 1 joints with both plasma-treated adhesive and adherends increased to 16.9 MPa, representing a 315% improvement compared to non-treated Comparative Example B joints and an additional 40% improvement compared to the Comparative Example A joints with only plasma-treated adherends and non-treated adhesive. Advantageously and unexpectedly, the average τs of the Inventive Example 1 joints can be comparable to metal-metal joints due to the plasma treating both the substrates and adhesive.

As discussed previously, the enhanced surface energy of the plasma-treated exposed adhesive strip is time-sensitive. Thus, the mechanical behavior of the joint specimens, specifically the lap shear strength of the joints, can be influenced by the amount of time that occurs between plasma treating the PX5005F adhesive and bonding the plasma-treated first and second substrate surfaces together with the plasma-treated exposed adhesive strip. As shown in Table II, as the time between treating the top and bottom surfaces of the PX5005F adhesive and bonding the plasma-treated first and second substrate surfaces together increased, the average τs of the joints decreases. Thus, bonding the plasma-treated first and second substrate surfaces together with the plasma-treated exposed adhesive strip shortly after plasma-treating the PX5005F adhesive can assist in maintaining the excellent lap shear strength of the adhesive joints.

### Fracture Morphologies

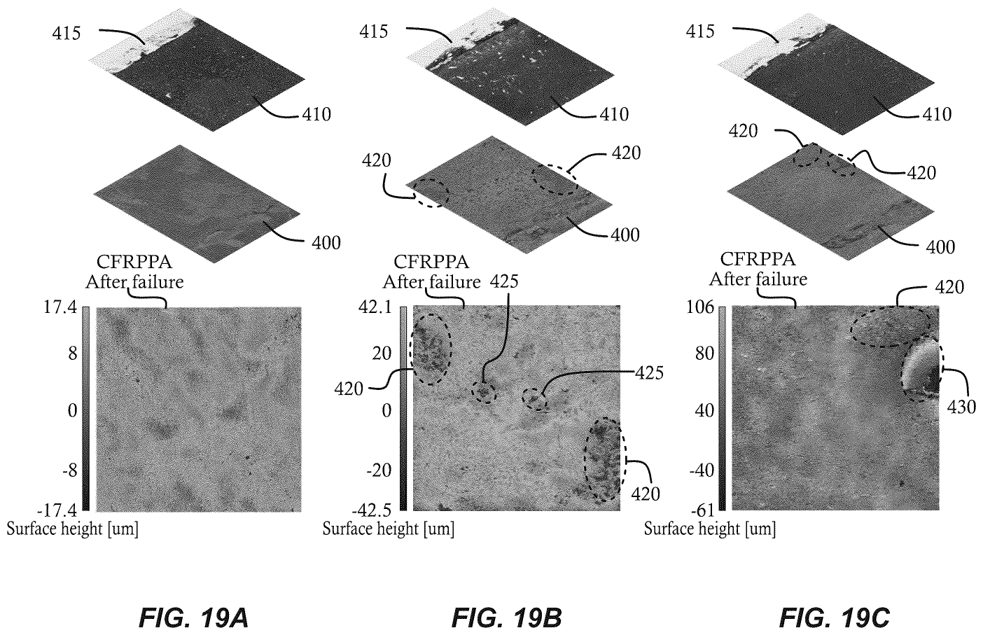

Fracture morphologies of the substrates were further investigated to identify the failure modes and lap shear behavior of the Inventive Example 1 and Comparative Example A-B joints. As illustrated in FIG. 19A, for a Comparative Example B joint with non-treated AA6061 415, CFRPPA 400, and PX5005F adhesive 410, the failure mode can be categorized as interfacial failure between CFRPPA substrate 400 and PX5005F adhesive 410 (also known as adhesive failure). This occurred due to the low fracture energy of the CFRPPA/PX5005F adhesive interface, confirming the low average lap shear strength (4.1 MPa) of the Comparative Example B joints with non-treated adherends and adhesive.

However, in the failed Comparative Example A joint with plasma-treated AA6061 415 and CFRPPA 400 and non-treated PX5005F adhesive 410, a combined failure mode of CFRPPA/PX5005F adhesive interfacial debonding and damage to the CFRPPA substrate 400, with fibers 420 peeled off to a depth of approximately 40 to 60 μm, can be observed in FIG. 19B. Also, small fragments of PX5005F adhesive 425 can be observed on the CFRPPA surface in FIG. 19B indicating damage in the PX5005F adhesive 410.

The plasma treatment of AA6061 415, CFRPPA 400, and PX5005F adhesive 410 surfaces in an Inventive Example 1 joint resulted in more extensive fiber peeling, with a deeper layer of approximately 100 μm fibers 420 peeled off from the CFRPPA substrate surface, as seen in FIG. 19C. This fiber peeling process also caused local deformation 430 of the CFRPPA 400 around the peeled fibers, as seen in FIG. 19C. Additionally, a small amount of damage was observed in the PX5005F adhesive 410 and small fragments of PX5005F adhesive can be observed near the local deformation 430 on the CFRPPA 400 surface. Yet, this was not the main failure mode compared to CFRPPA/PX5005F adhesive interfacial debonding and damage on the CFRPPA surface. The foregoing failure process in the CFRPPA and PX5005F adhesive, as well as the enhanced CFRPPA/PX5005F adhesive interfacial bonding induced by plasma treatment, led to more energy dissipation of Comparative Example A and Inventive Example 1 joints during the single lap shear testing. This confirmed the enhanced average lap shear strength of up to 12.2 MPa after plasma treatment of adherends only for Comparative Example A joints, and an average lap shear strength of up to 16.9 MPa after plasma treatment of CFRPPA surface, AA6061 surface, and PX5005F adhesive surfaces for Inventive Example 1 joints. The enhanced resistance of the Inventive Example 1 lap shear joints with plasma-treated adhesive and adherends can be mainly attributed to the improved adherend/adhesive interfacial bonding.

### Chemical Bonding

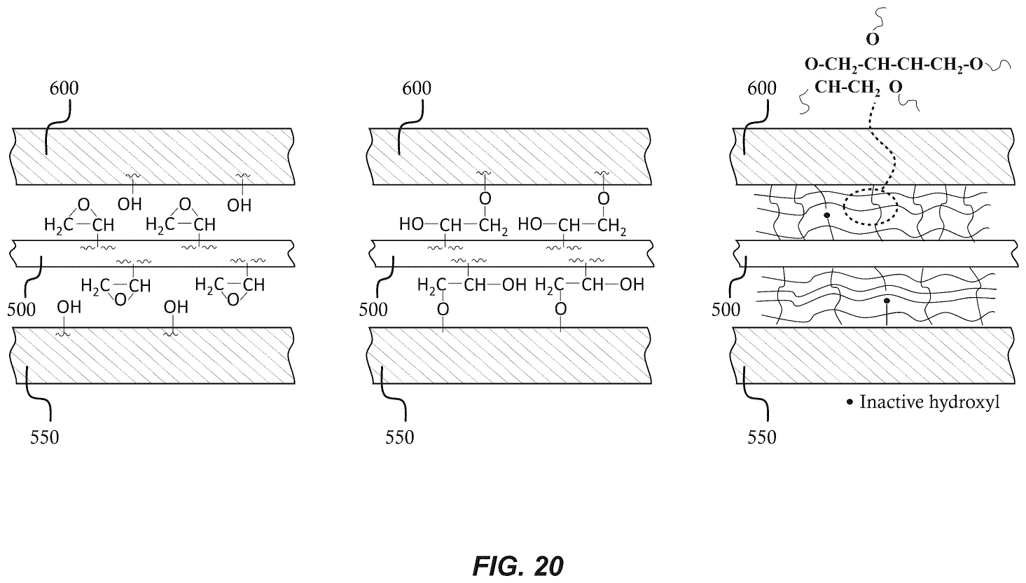

The chemical bonds at the substrate-adhesive interfaces were also investigated. Based on the ATR-FTIR and XPS results of the adhesives and substrate surfaces, the investigated plasma treatments do not change the types of chemical bonds formed at the substrate/adhesive interfaces. However, the densities of the interfacial chemical bonds increase after plasma treatment. As schematically shown in FIG. 20, the plasma treatment conducted on the substrates and PX5005F adhesive 500 surfaces activates more hydroxyl groups on the AA6061 550 and CFRPPA 600 surfaces and epoxy groups on the PX5005F adhesive 500 surfaces. As a result, the activated hydroxyl groups initiate the epoxy ring opening polymerization and form intra-molecular bonds, specifically covalent bonds. This polymerization process further leads to the formation of cross-linked bonds at the substrate/PX5005F adhesive interfaces, as shown in FIG. 20. The formation of a denser network of intra-molecular bonds is the key to significantly improving the interfacial debonding resistance between CFRPPA and AA6061 substrates and the PX5005F adhesive.

Additionally, hydroxyl-nitrile reactions can possibly happen at the AA6061/PX5005F adhesive and CFRPPA/PX5005F adhesive interfaces, and amine-epoxy reaction can also occur at the CFRPPA/PX5005F adhesive interface. However, those reactions are much less dominant compared to the cross-linked network formed due to hydroxyl-initiated epoxy ring opening polymerization discussed above.

For Comparative Example A and B, where only adherend surfaces are plasma-treated or all the surfaces are not plasma-treated, the cross-linked network at the substrate/adhesive interfaces is less dense than the case of plasma treating both the substrates and PX5005F adhesive due to the smaller amount of epoxy and hydroxyl groups participating in the above-mentioned polymerization process.

Furthermore, the plasma treatment conducted on the substrates and XP0012 adhesive activates more hydroxyl groups on the AA6061 and CFRPPA surfaces and hydroxyl, epoxy, and nitrile groups on the XP0012 adhesive paste surface. As a result, both hydroxyl and amine-initiated epoxy ring-opening polymerization and amide bonding occur at the AA6061/XP0012 adhesive interface, leading to crosslinking and linear bonding. At the CFRPPA/XP0012 adhesive interface, hydroxyl group-initiated amide bonding can be observed. The formation of a denser network of intra-molecular bonds is the key to significantly improving the interfacial debonding resistance between CFRPPA and AA6061 substrates and the XP0012 adhesive.

### Physical Changes

Physical changes to the surfaces and interfaces resulting from plasma modification were also investigated. The surface roughness and profile of both substrate and adhesive tape surfaces before and after plasma surface treatment were initially examined using three-dimensional profilometry. Notably, the plasma surface treatment parameters of the CFRPPA and AA6061 surfaces included a nozzle tip end to surface distance (d) of 6.4 mm, a nozzle tip speed (v) of 3.2 mm/s, and a step-over distance (so) of 9 mm. As shown in Table III, the surface roughness (Ra) and the highest difference between peak and valley on the surface (Re) of as-received substrates and PX5005F adhesive tape do not noticeably change after undergoing plasma treatment. For the AA6061 and adhesive tape surfaces, their Ra and R-values have negligible changes after plasma modification, showing a maximum increase of 0.3 μm, as shown in Table III. For the CFRPPA surface, while the average surface roughness remains almost the same after plasma modification, the other parameter, Re_{z}, increases by approximately 4 μm, as shown in Table III. This slight increase can be explained by the fact that the plasma-generated temperature on the CFRPPA surface in this work can be higher than its glass transition temperature (about 135° C.), thus causing the deformation of PPA on the CFRPPA surface during plasma surface modification.

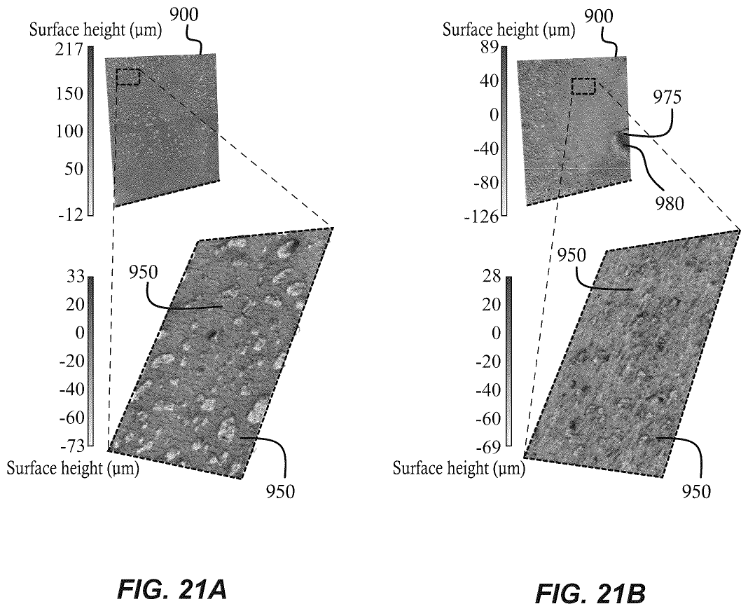

Besides investigating surface roughness, an additional profilometry investigation was performed on the presence of voids at the interface between the adherend surface and the adhesive surface, which is a crucial parameter governing the debonding resistance. For the Comparative Example B joints, with both non-treated adherends and adhesive, after single lap shear testing, the AA6061 surface 900 attached with PX5005F adhesive is characterized by a large amount of voids 950, as can be seen in FIG. 21A. These voids must be located at the interface between the PX5005F adhesive tape surface and the CFRPPA surface, as a complete debonding at the weak CFRPPA/PX5005F adhesive interface describes the failure of non-treated AA6061-CFRPPA dissimilar joints. For the Inventive Example 1 joints, with both plasma-treated adherends and adhesive, after single lap shear testing, the AA6061 surface 900 attached with PX5005F adhesive is characterized by a reduced amount of voids 950, as can be seen in FIG. 21B. Additionally, fibers peeled off from the CFRPPA substrate 975 and peeled PX5005F adhesive 980 can be seen in FIG. 21B.

The interfacial void area fraction (V_{if}), calculated by taking the void area on the adhesive tape surface and dividing it by the entire bonded area, at the Comparative Example B non-treated CFRPPA/PX5005F adhesive interface can reach up to approximately 21%, as shown in Table I. This measurement was obtained by analyzing the surface height profile, showing lower values representing the voids. The Vif at the interface between plasma-treated CFRPPA and non-treated adhesive tape surfaces was 20%, as shown in Table I. Advantageously and unexpectedly, plasma modification of both adherends and adhesive surfaces led to a Vif of approximately 14%, as shown in Table I. Beneficially, the reduced interfacial void fraction Vif can lead to an increase in the distance between interfacial voids, thereby helping to mitigate stress concentration between the voids.

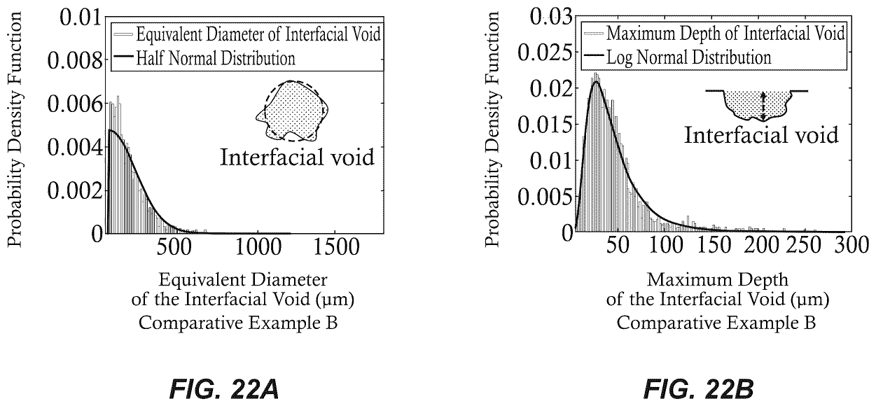

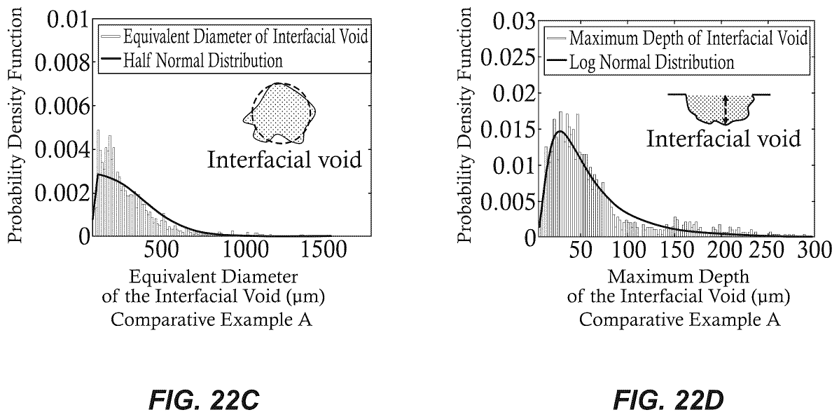

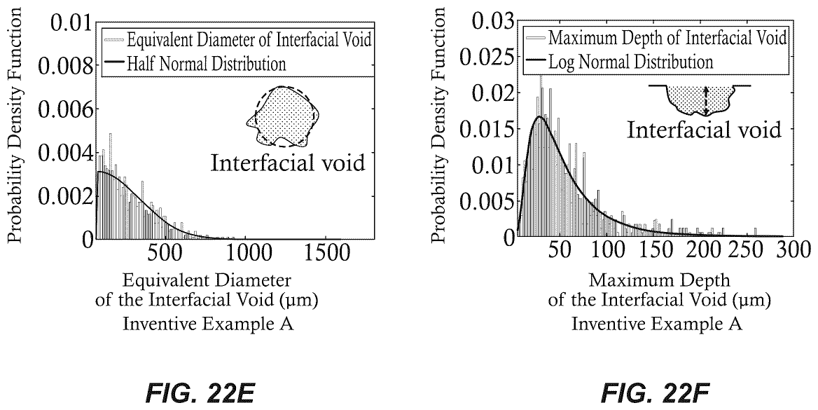

A detailed profilometry study for the statistical distributions of interfacial void size and maximum void depth was conducted, and the results are plotted in FIGS. 22A-22F. For the maximum interfacial void depth (dₘₐₓ) at the CFRPPA/adhesive interface, it follows a log-normal distribution, and the distribution shape does not exhibit a significant change before and after plasma treatment, as shown in the FIG. 22B, FIG. 22D, and FIG. 22F plots. The dₘₐₓ corresponding to the peak of the probability density function (PDF) was approximately 25 μm, and the largest dₘₐₓ was close to 250 μm (approximately equal to the adhesive tape thickness). This aspect indicates that the majority of the interfacial voids were shallow, with only a few interface voids penetrating the entire adhesive tape thickness. On the other hand, for the interfacial void size, an equivalent diameter (l_{eq}) was defined by equating the area of a circular interfacial void with that of a real interfacial void with irregular geometry. As plotted in FIGS. 22A, 22C, and 22E, for the PDF with respect to the l_{eq}, the interfacial void size at the CFRPPA/adhesive interfaces before and after plasma treatment can all be described by a half-normal distribution, but the shape of the distribution changes noticeably after plasma treatment. More specifically, the scale parameter (σ), representing the width of a half-normal distribution, increases from 168 μm (Comparative Example B, non-treated joint) to 282 μm (Comparative Example A, joint with plasma-treated adherends only) to 256 μm (Inventive Example 1, joint with plasma-treated adherends and PX5005F adhesive). This means that the range of interfacial void sizes at the CFRPPA/PX5005F adhesive interface increases after plasma surface modification, which can be attributed to the coalescence of small interfacial voids, resulting from the changes in chemistry and surface energy at the CFRPPA/PX5005F adhesive interface after plasma treatment. As a result, the changes in interfacial void size also altered the distance between the interfacial voids.

The changes in interfacial void area fraction, size, and distribution due to plasma treatment can significantly affect the stress concentration in the region among the interfacial voids. The foregoing results indicate that the significantly improved lap shear behavior of the Inventive Example 1 joints could be attributed to the combined effects of plasma-enhanced chemical bonding and plasma-induced physical changes of micron-sized interfacial voids including the reduction of the interfacial void area fraction (V_{if}).

TABLE I

| Example | IE 1 | IE 2 | CE A | CE B |
|---|---|---|---|---|
| Plasma-treat CFRPPA and AA6061 | Yes | Yes | Yes | No |
| substrates | | | | |
| Plasma-treat PX5005F adhesive tape | Yes | — | No | No |
| Plasma-treat XP0012 adhesive paste | — | Yes | — | — |
| Average τs (MPa) | 16.9 | — | 12.2 | 4.1 |
| V_{if} (%) | 21 | — | 20 | 14 |

TABLE II

| Example | Average τs (MPa) |
|---|---|
| CE B | 4.1 |
| CE A | 12.2 |
| IE 1 | 16.9 |
| IE 1 - Except bond | 14.1 |
| substrates 4 hours after | |
| plasma treating PX5005F | |
| adhesive | |
| IE 1 - Except bond | 13.1 |
| substrates 48 hours after | |
| plasma treating PX5005F | |
| adhesive | |
| IE 1 - Except bond | 12.1 |
| substrates 96 hours after | |
| plasma treating PX5005F | |
| adhesive | |
| IE 1 - Except bond | 11.9 |
| substrates 196 hours after | |
| plasma treating PX5005F | |
| adhesive | |

TABLE III

| | | | | | As- | Plasma- |
|---|---|---|---|---|---|---|
| | As- | Plasma- | As- | Plasma- | received | treated |
| | received | treated | received | treated | PX5005F | PX5005F |
| Material | CFRPPA | CFRPPA | AA6061 | AA6061 | adhesive | adhesive |
| Rₐ (μm) | 2.8 | 3.0 | 1.2 | 1.2 | 2.1 | 2.1 |
| R_{z} (μm) | 28.6 | 32.5 | 10.9 | 10.6 | 16.8 | 16.7 |

The invention is described above with reference to numerous aspects and specific examples. Many variations will suggest themselves to those skilled in the art in light of the above detailed description. All such obvious variations are within the full intended scope of the appended claims. Other aspects of the invention can include, but are not limited to, the following (aspects are described as “comprising” but, alternatively, can “consist essentially of” or “consist of”′ unless specifically stated otherwise):
Aspect 1. A method to produce an adhesive joint, the method comprising: plasma treating a first substrate at a first power level to form a plasma-treated first substrate surface;
   plasma treating a second substrate at a second power level to form a plasma-treated second substrate surface;
   plasma treating a top surface and a bottom surface of an exposed adhesive strip at a third power level to form a plasma-treated exposed adhesive strip;
   joining the plasma-treated first substrate surface and the plasma-treated second substrate surface together with the plasma-treated exposed adhesive strip; and
   curing the plasma-treated exposed adhesive strip to produce the adhesive joint.
Aspect 2. An adhesive joint made by the process of: plasma treating a first substrate at a first power level to form a plasma-treated first substrate surface;
   plasma treating a second substrate at a second power level to form a plasma-treated second substrate surface;
   plasma treating a top surface and a bottom surface of an exposed adhesive strip at a third power level to form a plasma-treated exposed adhesive strip;
   joining the plasma-treated first substrate surface and the plasma-treated second substrate surface together with the plasma-treated exposed adhesive strip; and
   curing the plasma-treated exposed adhesive strip to produce the adhesive joint.
Aspect 3. The method defined in aspects 1-2, wherein the first power level and the second power level are the same.
Aspect 4. The method defined in any one of aspects 1-3, wherein the first power level and the second power level are higher than the third power level.
Aspect 5. The method defined in any one of aspects 1-4, wherein the first power level generates enough plasma energy to activate the functional groups on the first substrate surface.
Aspect 6. The method defined in any one of aspects 1-5, wherein the second power level generates enough plasma energy to activate the functional groups on the second substrate surface.
Aspect 7. The method defined in aspects 5 or 6, wherein the functional groups comprise hydroxyl groups, carboxyl groups, carbonyl groups (e.g., hydrated and/or monomeric), amine groups, amide groups, and any combination thereof.
Aspect 8. The method defined in any one of aspects 1-7, wherein the first power level generates a controlled amount plasma energy to prevent cross-linking and/or chain scission within the first substrate.
Aspect 9. The method defined in any one of aspects 1-8, wherein the second power level generates a controlled amount plasma energy to prevent cross-linking and/or chain scission within the second substrate.
Aspect 10. The method defined in any one of aspects 1-9, wherein the third power level generates enough plasma energy to activate the functional groups on the top and bottom surfaces of the exposed adhesive strip.
Aspect 11. The method defined in aspect 10, wherein the functional groups comprise epoxy groups, carbonyl groups, nitrile groups, amine groups, hydroxyl groups, or any combination thereof.
Aspect 12. The method defined in any one of aspects 1-11, wherein the third power level generates a controlled amount plasma energy to prevent cross-linking and/or chain scission within the exposed adhesive strip.
Aspect 13. The method defined in any one of aspect 1-12, wherein the exposed adhesive strip comprises at least one epoxy resin, at least one curing agent, and/or at least one additive.
Aspect 14. The method defined in aspect 13, wherein the epoxy resin comprises a phenol-formaldehyde polymer with glycidyl ether, bisphenol A-epoxy resin, diglycidylether-bisphenol A (DGEBA), an acrylic polymer, or any combination thereof.
Aspect 15. The method defined in aspect 13, wherein the curing agent comprises dicyandiamide (DICY).
Aspect 16. The method defined in aspect 13, wherein the additive comprises a filler, plasticizer, stabilizer, tackifier, cross-linking agent, solvent, colorant, or any combination thereof.
Aspect 17. The method defined in any one of aspects 1-16, wherein the first substrate and the second substrate are different.
Aspect 18. The method defined in any one of aspects 1-17, wherein the first substrate comprises a thermoplastic, a carbon-fiber reinforced thermoplastic, a glass-fiber reinforced thermoplastic, a natural-fiber reinforced thermoplastic, or any combination thereof.
Aspect 19. The method defined in aspect 18, wherein the carbon-fiber modified thermoplastic is a carbon-fiber reinforced polyphthalamide (CFRPPA).
Aspect 20. The method defined in any one of aspects 1-19, wherein the second substrate comprises a metal, a metal alloy, or any combination thereof.
Aspect 21. The method defined in aspect 20, wherein the metal and/or the metal alloy comprises aluminum.
Aspect 22. The method defined in any one of aspects 1-21, wherein the chemical bond density at the surface of the plasma-treated first substrate is greater than the chemical bond density at the surface of the first substrate before plasma treatment.
Aspect 23. The method defined in any one of aspect 1-22, wherein the surface energy of the plasma-treated first substrate is greater than the surface energy of the first substrate before plasma treatment.
Aspect 24. The method defined in any one of aspects 1-23, wherein the chemical bond density at the surface of the plasma-treated second substrate is greater than the chemical bond density at the surface of the second substrate before plasma treatment.
Aspect 25. The method defined in any one of aspect 1-24, wherein the surface energy of the plasma-treated second substrate is greater than the surface energy of the second substrate before plasma treatment.
Aspect 26. The method defined in any one of aspects 1-25, wherein the chemical bond density at the top surface and the bottom surface of the plasma-treated exposed adhesive strip is greater than the chemical bond density at the top surface and the bottom surface of the exposed adhesive strip before plasma treatment.
Aspect 27. The method defined in any one of aspects 1-26, wherein the surface energy of the plasma-treated exposed adhesive strip is greater than the surface energy of the exposed adhesive strip before plasma treatment.
Aspect 28. The method defined in any one of aspects 1-27, wherein the first substrate is plasma-treated at the first power level, the second substrate is plasma-treated at the second power level, and the exposed adhesive strip is plasma-treated at the third power level in any order or simultaneously.
Aspect 29. The method defined in any one of aspects 1-28, wherein the first substrate and the second substrate are plasma-treated with a plasma generator or reactor.
Aspect 30. The method defined in aspect 29, wherein the plasma generator or reactor comprises a blown-ion plasma system.
Aspect 31. The method defined in aspect 29 or 30, wherein a gas or mixture of gases is introduced into the plasma generator or reactor.
Aspect 32. The method defined in aspect 31, wherein the gas or mixture of gases comprises compressed air.
Aspect 33. The method defined in any one of aspects 1-32, wherein the top surface and the bottom surface of the exposed adhesive strip are plasma-treated with a plasma generator or reactor.
Aspect 34. The method defined in aspect 33, wherein the plasma generator or reactor is a low-power expanded plasma cleaner with an adjustable radio frequency setting.
Aspect 35. The method defined in aspect 33 or 34, wherein a gas or mixture of gases is introduced into the plasma generator or reactor.
Aspect 36. The method defined in aspect 35, wherein the gas or mixture of gases comprises oxygen and/or argon.
Aspect 37. The method defined in any one of aspects 1-36, wherein the top and bottom surfaces of the exposed adhesive strip are plasma-treated for 10 minutes.
Aspect 38. The method defined in any one of aspects 1-37, wherein joining the plasma-treated first substrate surface and the plasma-treated second substrate surface together with the plasma-treated exposed adhesive strip is performed under pressure.
Aspect 39. The method defined in any one of aspects 1-38, wherein the plasma-treated exposed adhesive strip is cured in a conventional oven at a temperature of 150° C. for 45 minutes.
Aspect 40. The method defined in any one of aspects 1-39, wherein the average lap shear strength of the adhesive joint is greater than the average lap shear strength of an adhesive joint in which the exposed adhesive strip is not plasma-treated.
Aspect 41. The method defined in any one of aspects 1-40, wherein the interfacial void area fraction (V_{if}) percentage of interfacial voids between the plasma-treated exposed adhesive strip and the plasma-treated first substrate is less than the interfacial void area fraction (Vis) percentage of an adhesive joint in which the exposed adhesive strip is not plasma-treated.
Aspect 42. The method defined in any one of aspects 1-41, wherein the adhesive joint has an average lap shear strength of from 10 MPa to 40 MPa, from 12 MPa to 35 MPa, or from 15 MPa to 30 MPa.
Aspect 43. A method to produce an adhesive joint, the method comprising: plasma treating a first substrate at a first power level to form a plasma-treated first substrate surface;
   plasma treating a second substrate at a second power level to form a plasma-treated second substrate surface;
   applying a layer of flowable adhesive onto the plasma-treated second substrate surface and plasma treating the layer of flowable adhesive at a third power level to form a plasma-treated layer of flowable adhesive;
   joining the plasma-treated first substrate surface with the plasma-treated layer of flowable adhesive positioned on the plasma-treated second substrate surface; and
   curing the plasma-treated layer of flowable adhesive to produce the adhesive joint.
Aspect 44. An adhesive joint made by the process of:
   plasma treating a first substrate at a first power level to form a plasma-treated first substrate surface;
   plasma treating a second substrate at a second power level to form a plasma-treated second substrate surface;
   applying a layer of flowable adhesive onto the plasma-treated second substrate surface and plasma treating the layer of flowable adhesive at a third power level to form a plasma-treated layer of flowable adhesive;
   joining the plasma-treated first substrate surface with the plasma-treated layer of flowable adhesive positioned on the plasma-treated second substrate surface; and
   curing the plasma-treated layer of flowable adhesive to produce the adhesive joint.
Aspect 45. The method defined in aspect 43 and 44, wherein the layer of flowable adhesive comprises a liquid and/or a paste.
Aspect 46. The method defined in any one of aspects 43-45, wherein the first power level and the second power level are the same.
Aspect 47. The method defined in any one of aspects 43-46, wherein the first power level and the second power level are higher than the third power level.
Aspect 48. The method defined in any one of aspects 43-47, wherein the first power level generates enough plasma energy to activate the functional groups on the first substrate surface.
Aspect 49. The method defined in any one of aspects 43-48, wherein the second power level generates enough plasma energy to activate the functional groups on the second substrate surface.
Aspect 50. The method defined in aspects 48 or 49, wherein the functional groups comprise hydroxyl groups, carboxyl groups, carbonyl groups (e.g., hydrated and/or monomeric), amine groups, amide groups, and any combination thereof.
Aspect 51. The method defined in any one of aspects 43-50, wherein the first power level generates a controlled amount plasma energy to prevent cross-linking and/or chain scission within the first substrate.
Aspect 52. The method defined in any one of aspects 43-51, wherein the second power level generates a controlled amount plasma energy to prevent cross-linking and/or chain scission within the second substrate.
Aspect 53. The method defined in any one of aspects 43-52, wherein the third power level generates enough plasma energy to activate the functional groups on the surface of the layer of flowable adhesive.
Aspect 54. The method defined in aspect 53, wherein the functional groups comprise epoxy groups, carbonyl groups, nitrile groups, amine groups, hydroxyl groups, or any combination thereof.
Aspect 55. The method defined in any one of aspects 43-54, wherein the third power level generates a controlled amount plasma energy to prevent cross-linking and/or chain scission within the layer of flowable adhesive.
Aspect 56. The method defined in any one of aspect 43-55, wherein the layer of flowable adhesive comprises at least one epoxy resin, at least one curing agent, and/or at least one additive.
Aspect 57. The method defined in aspect 56, wherein the epoxy resin comprises a phenol-formaldehyde polymer with glycidyl ether, bisphenol A-epoxy resin, diglycidylether-bisphenol A (DGEBA), an acrylic polymer, or any combination thereof.
Aspect 58. The method defined in aspect 56, wherein the curing agent comprises dicyandiamide (DICY).
Aspect 59. The method defined in aspect 56, wherein the additive comprises a filler, plasticizer, stabilizer, tackifier, cross-linking agent, solvent, colorant, or any combination thereof.
Aspect 60. The method defined in any one of aspects 43-59, wherein the first substrate and the second substrate are different.
Aspect 61. The method defined in any one of aspects 43-60, wherein the first substrate comprises a thermoplastic, a carbon-fiber reinforced thermoplastic, a glass-fiber reinforced thermoplastic, a natural-fiber reinforced thermoplastic, or any combination thereof.
Aspect 62. The method defined in aspect 61, wherein the carbon-fiber modified thermoplastic is a carbon-fiber reinforced polyphthalamide (CFRPPA).
Aspect 63. The method defined in any one of aspects 43-62, wherein the second substrate comprises a metal, a metal alloy, or any combination thereof.
Aspect 64. The method defined in aspect 63, wherein the metal and/or the metal alloy comprises aluminum.
Aspect 65. The method defined in any one of aspects 43-64, wherein the chemical bond density at the surface of the plasma-treated first substrate is greater than the chemical bond density at the surface of the first substrate before plasma treatment.
Aspect 66. The method defined in any one of aspect 43-65, wherein the surface energy of the plasma-treated first substrate is greater than the surface energy of the first substrate before plasma treatment.
Aspect 67. The method defined in any one of aspects 43-66, wherein the chemical bond density at the surface of the plasma-treated second substrate is greater than the chemical bond density at the surface of the second substrate before plasma treatment.
Aspect 68. The method defined in any one of aspect 43-67, wherein the surface energy of the plasma-treated second substrate is greater than the surface energy of the second substrate before plasma treatment.
Aspect 69. The method defined in any one of aspects 43-68, wherein the chemical bond density at the surface of the plasma-treated layer of flowable adhesive is greater than the chemical bond density at the surface of the layer of flowable adhesive before plasma treatment.
Aspect 70. The method defined in any one of aspects 43-69, wherein the surface energy of the plasma-treated layer of flowable adhesive is greater than the surface energy of the layer of flowable adhesive before plasma treatment.
Aspect 71. The method defined in any one of aspects 43-70, wherein the first substrate is plasma-treated at the first power level, the second substrate is plasma-treated at the second power level, and the layer of flowable adhesive is plasma-treated at the third power level in any order or simultaneously.
Aspect 72. The method defined in any one of aspects 43-71, wherein the first substrate and the second substrate are plasma-treated with a plasma generator or reactor.
Aspect 73. The method defined in aspect 72, wherein the plasma generator or reactor comprises a blown-ion plasma system.
Aspect 74. The method defined in aspect 72 or 73, wherein a gas or mixture of gases is introduced into the plasma generator or reactor.
Aspect 75. The method defined in aspect 74, wherein the gas or mixture of gases comprises compressed air.
Aspect 76. The method defined in any one of aspects 43-75, wherein the surface of the layer of flowable adhesive is plasma-treated with a plasma generator or reactor.
Aspect 77. The method defined in aspect 76, wherein the plasma generator or reactor is a low-power expanded plasma cleaner with an adjustable radio frequency setting.
Aspect 78. The method defined in aspect 76 or 77, wherein a gas or mixture of gases is introduced into the plasma generator or reactor.
Aspect 79. The method defined in aspect 78, wherein the gas or mixture of gases comprises oxygen and/or argon.
Aspect 80. The method defined in any one of aspects 43-79, wherein the layer of flowable adhesive is plasma-treated for 10 minutes.
Aspect 81. The method defined in any one of aspects 43-80, wherein the joining the plasma-treated first substrate surface with the plasma-treated layer of flowable adhesive positioned on the plasma-treated second substrate surface is performed under pressure.
Aspect 82. The method defined in any one of aspects 43-81, wherein the plasma-treated layer of flowable adhesive is cured in a conventional oven at a temperature of 150° C. for 45 minutes.
Aspect 83. The method defined in any one of aspects 43-82, wherein the average lap shear strength of the adhesive joint is greater than the average lap shear strength of an adhesive joint in which the layer of flowable adhesive is not plasma-treated.
Aspect 84. The method defined in any one of aspects 43-83, wherein the interfacial void area fraction (V_{if}) percentage of interfacial voids between the plasma-treated layer of flowable adhesive and the plasma-treated first substrate is less than the interfacial void area fraction (V_{if}) percentage of an adhesive joint in which the layer of flowable adhesive is not plasma-treated.
Aspect 85. The method defined in any one of aspects 43-84, wherein the adhesive joint has an average lap shear strength of from 10 MPa to 40 MPa, from 12 MPa to 35 MPa, or from 15 MPa to 30 MPa.

We claim:

1. A method to produce an adhesive joint, the method comprising:
plasma treating a first substrate at a first power level to form a plasma-treated first substrate surface;
plasma treating a second substrate at a second power level to form a plasma-treated second substrate surface;
plasma treating a top surface and a bottom surface of an exposed adhesive strip at a third power level to form a plasma-treated exposed adhesive strip;
joining the plasma-treated first substrate surface and the plasma-treated second substrate surface together with the plasma-treated exposed adhesive strip; and
curing the plasma-treated exposed adhesive strip to produce the adhesive joint.

2. The method of claim 1, wherein the first substrate is composed of a material different from that of the second substrate.

3. The method of claim 1, wherein:
the first power level and the second power level are the same; and
the first power level and the second power level are higher than the third power level.

4. The method of claim 1, wherein:
the first power level generates enough plasma energy to generate functional groups on the first substrate surface; and
the second power level generates enough plasma energy to generate functional groups on the second substrate surface.

5. The method of claim 4, wherein the functional groups on the first substrate surface and/or the functional groups on the second substrate surface comprise hydroxyl groups, carboxyl groups, carbonyl groups, amine groups, amide groups, or any combination thereof.

6. The method of claim 1, wherein the exposed adhesive strip comprises at least one epoxy resin and at least one curing agent.

7. The method of claim 1, wherein the first substrate comprises a thermoplastic, a carbon-fiber reinforced thermoplastic, a glass-fiber reinforced thermoplastic, a natural-fiber reinforced thermoplastic, or any combination thereof.

8. The method of claim 1, wherein:
the second substrate comprises a metal or a metal alloy.

9. The method of claim 1, wherein:
a surface energy of the plasma-treated first substrate is greater than a surface energy of the first substrate before plasma treatment;
a surface energy of the plasma-treated second substrate is greater than a surface energy of the second substrate before plasma treatment; and
a surface energy of the plasma-treated exposed adhesive strip is greater than a surface energy of the exposed adhesive strip before plasma treatment.

10. The method of claim 1, wherein:
a chemical bond density at the surface of the plasma-treated first substrate is greater than a chemical bond density at the surface of the first substrate before plasma treatment;
a chemical bond density at the surface of the plasma-treated second substrate is greater than a chemical bond density at the surface of the second substrate before plasma treatment; and
a chemical bond density at the top surface and the bottom surface of the plasma-treated exposed adhesive strip is greater than a chemical bond density at the top surface and the bottom surface of the exposed adhesive strip before plasma treatment.

11. The method of claim 1, wherein the joining the plasma-treated first substrate surface and the plasma-treated second substrate surface together with the plasma-treated exposed adhesive strip is performed under pressure.

12. The method of claim 1, wherein curing of the plasma-treated exposed adhesive strip is conducted at at least 150° C.

13. An adhesive joint made by the process of:
plasma treating a first substrate at a first power level to form a plasma-treated first substrate surface;
plasma treating a second substrate at a second power level to form a plasma-treated second substrate surface;
plasma treating a top surface and a bottom surface of an exposed adhesive strip at a third power level to form a plasma-treated exposed adhesive strip;
joining the plasma-treated first substrate surface and the plasma-treated second substrate surface together with the plasma-treated exposed adhesive strip; and
curing the plasma-treated exposed adhesive strip to produce the adhesive joint.

14. The adhesive joint of claim 13, wherein the first substrate is composed of a material different from that of the second substrate.

15. The adhesive joint of claim 13, wherein:
the first power level and the second power level are the same; and
the first power level and the second power level are higher than the third power level.

16. The adhesive joint of claim 13, wherein the process comprises generating functional groups on the first substrate surface and/or the second substrate surface that comprise hydroxyl groups, carboxyl groups, carbonyl groups, amine groups, amide groups, or any combination thereof.

17. An adhesive joint made by the process of:
plasma treating a first substrate at a first power level to form a plasma-treated first substrate surface;
plasma treating a second substrate at a second power level to form a plasma-treated second substrate surface;
applying a layer of flowable adhesive onto the plasma-treated second substrate surface and plasma treating the layer of flowable adhesive at a third power level to form a plasma-treated layer of flowable adhesive;
joining the plasma-treated first substrate surface with the plasma-treated layer of flowable adhesive positioned on the plasma-treated second substrate surface; and
curing the plasma-treated layer of flowable adhesive to produce the adhesive joint.

18. The adhesive joint of claim 17, wherein the flowable adhesive comprises a liquid and/or a paste.

19. The adhesive joint of claim 17, wherein:
the plasma-treating of the layer of flowable adhesive is conducted with a plasma generator or reactor; and
a gas or mixture of gases is introduced into the plasma generator or reactor.

20. The adhesive joint of claim 17, wherein the process comprises generating functional groups on the first substrate surface and/or the second substrate surface that comprise hydroxyl groups, carboxyl groups, carbonyl groups, amine groups, amide groups, or any combination thereof.
